(19) United States
(12) Patent Application Publication
(10) Pub. No.: US 2014/0242250 A1
(43) Pub. Date: Aug. 28, 2014

(54) LOW FAT SPREAD

(71) Applicants: Paul Wassell, East Sussex (GB); Mark Farmer, Oron la Ville (CH); Stuart Andrew Warner, Copenhagen K (DK); Allan Torben Bech, Brabrand (DK); Niall W.G Young, Tjele (DK); Graham Bonwick, Cheshire (GB); Christopher Smith, Manchester (GB)

(72) Inventors: Paul Wassell, East Sussex (GB); Mark Farmer, Oron la Ville (CH); Stuart Andrew Warner, Copenhagen K (DK); Allan Torben Bech, Brabrand (DK); Niall W.G Young, Tjele (DK); Graham Bonwick, Cheshire (GB); Christopher Smith, Manchester (GB)

(73) Assignee: DUPONT NUTRITION BIOSCIENCES APS, Copenhagen K (DK)

(21) Appl. No.: 14/124,832

(22) PCT Filed: Jun. 8, 2012
(86) PCT No.: PCT/GB2012/051296

§ 371 Date: Dec. 9, 2013

Related U.S. Application Data
(60) Provisional application No. 61/497,734, filed on Jun. 16, 2011.

(30) Foreign Application Priority Data
Jun. 9, 2011 (GB) 1109654.2

(51) Int. Cl. A23D 7/00

(52) U.S. Cl. CPC A23D 7/001
USPC 426/602

(57) ABSTRACT

The present invention provides a foodstuff in the form of a spread, wherein the spread is a water in oil emulsion containing
(a) a continuous fat phase
(b) a dispersed aqueous phase,
   wherein the spread comprises
   (i) triglycerides in an amount of less than 41 wt % based on the foodstuff
   (ii) a mono or di ester of glycerol and Moringa oil.

### FIELD OF INVENTION

The present invention relates to a spread. In particular, the present invention relates to a low fat spread comprising an emulsifier derivable from a food source and which is advantageous over prior emulsifiers.

### BACKGROUND

An emulsion is a colloid consisting of a stable mixture of two immiscible phases, typically liquid phases in which small droplets of one phase are dispersed uniformly throughout the other. A typical emulsion is an oil and water emulsion, such as a water-in-oil emulsion. Emulsions may, for example, be industrial emulsions such as water-containing crude oils emulsified by addition of surface active substances, or edible emulsions such as mayonnaise, salad cream or margarine.

Emulsions are typically stabilised by the addition of an emulsifier and many effective emulsifiers are known. However, the use of these effective emulsifiers may become problematic if the separation of the emulsion into its component phases is desired. For example, many oil and water emulsions having industrial applications may need to be disposed of at the end of their useful life. This could be done by incineration, but the presence of water makes the cost of incineration high and thus breaking the emulsion and separating the water phase would be desirable. In the food industry, separating the oil/fat phase from the water phase of an emulsion foodstuff may be desirable in order to rework or analyse the foodstuff. The recovery of the oil/fat phase may also have cost benefits since it is a valuable component of the emulsion.

Polyglycerol polyricinoleate (PGPR) is a particularly effective emulsifier. Emulsions, in particular water-in-oil emulsions, prepared with PGPR are typically very stable and therefore separation of such emulsions into their component phases is known to be problematic.

Some methods for breaking oil and ater emulsions are known in the prior art.

U.S. Pat. No. 4,115,598 relates to water-in-oil type emulsions of a fat content of 35 to 65 percent which destabilise at body temperature. The emulsions contain a fat blend having a solids content of 10-35 percent at all temperatures from 10-20° C., a difference in solids content at 10° and 20° C. of no more than 10 percent and a solids content at 30° C. of less than 5 percent. Monoglycerides, preferably of an iodine value of 20 to 100 are present and preferably oil-in water emulsion promoting emulsifiers as well.

U.S. Pat. No. 6,310,106 discloses a process for breaking an emulsion into a water phase and an oil phase having particular application in crude oil emulsions. The process involves contacting the emulsion with a demulsifying effective amount of an alkoxylated C₁₀₋₂₄ carboxylic acid ester derived by the addition of ethylene oxide and/or propylene oxide onto a ring opened epoxidised C₁₀₋₂₄ carboxylic acid triglyceride which is ring opened with a C₆₋₁₈ carboxylic acid.

In view of the above, it would be desirable to produce a food or feed containing an emulsifier which does not exhibit such disadvantages when present in a system which may require separation.

### SUMMARY ASPECTS OF THE PRESENT INVENTION

In one aspect, the present invention provides a foodstuff in the form of a spread, wherein the spread is a water in oil emulsion containing

(a) a continuous fat phase
(b) a dispersed aqueous phase,
wherein the spread comprises
(i) triglycerides in an amount of less than 41 wt % based on the foodstuff
(ii) a mono or di ester of glycerol and Moringa oil.

In one aspect, the present invention provides a process for preparing a foodstuff in the form of a spread, wherein the spread comprises triglycerides in an amount of less than 41 wt % based on the foodstuff,

comprising the steps of
(a) contacting
(i) a fat phase; and
(ii) an aqueous phase;
   (b) forming an emulsion wherein the fat phase provides a continuous phase and wherein the aqueous phase provides a dispersed phase; and
   (c) contacting the fat phase and the aqueous phase either before step (b) or after step (b) with a mono or di ester of glycerol and Moringa oil.

In one aspect, the present invention provides use of a mono or di ester of glycerol and Moringa oil to prepare or stabilise a spread, wherein the spread is a water in oil emulsion containing

(a) a continuous fat phase
(b) a dispersed aqueous phase,
wherein the spread comprises (i) triglycerides in an amount of less than 41 wt % based on the foodstuff.

It has been surprisingly found that oil from plants from the genus Moringa may be used in the preparation of mono or diesters of glycerol, commonly known to one skilled in the art as mono and di glycerides, which has particular advantages in respect of the stability of emulsions formed by its use as an emulsifier. The present applicants have surprisingly found that an emulsion prepared using the Moringa mono and di glycerides may be sufficiently stable to be used in demanding application but which is not overly stable. Thus if it is desired, the emulsion may be separated into its component phases. Separating an emulsion into its component phases is often of great importance in the preparation of low fat spreads. The present invention may be used in one aspect to separate oil and water emulsions, such as water in oil emulsions, for example edible spreads. The oil phase thus separated may be reused in the production of further edible spreads. The water phase thus separated may be reliably analysed to provide information on the composition, in particular the salt content, of the initial spread.

We have further found that as well as being an effective emulsifier which allows for ready separation of phases, the mono or di ester of glycerol and Moringa oil is particularly advantageous as a source of oil to prepare the mono and di glycerides because the plant has been known as a source of edible materials for many years. Therefore the oil obtained from the plant may be regarded as safe for consumption. The use of mono and di glycerides prepared from Moringa oil has not previously been taught.

Moringa is the sole genus in the flowering plant family Moringaceae. The 13 species it contains are from tropical and subtropical climates and range in size from tiny herbs to very large trees. Moringa may therefore be grown in many climates in which cash crops may not currently be cultivated. Moringa cultivation is promoted as a means to combat poverty and malnutrition and the plant grows quickly in many types of environments. The seeds contain 30-50% oil and may produce 100-200 gal/acre/year. Moringa species are drought-resistant and can grow in a wide variety of poor soils, even barren ground, with soil pH between 4.5 and 9.0.

### DETAILED DESCRIPTION

As discussed above, in one aspect, the present invention provides a foodstuff in the form of a spread, wherein the spread is a water in oil emulsion containing

(a) a continuous fat phase
(b) a dispersed aqueous phase,
wherein the spread comprises
(i) triglycerides in an amount of less than 41 wt % based on the foodstuff
(ii) a mono or di ester of glycerol and Moringa oil.

### Moringa

It will be appreciated by one skilled in the art that the term ‘Moringa’ refers to the sole genus in the flowering plant family Moringaceae.

As discussed in Pandey A., Pradheep, K., Gupta, R., Roshini Nayar, E., Bhandari, D. C., (2010) Drumstick tree, Moringa oleifera Lam, a multipurpose potential species in India, Genetic Resources and Crop Evolution, Springer, the genus Moringa Adans. (family Moringaceae) has more than 13 species (Verdcourt 1985), of which two species viz. M. oleifera Lam. (syn. M. pterygosperma Gaertn.) and M. concanensis Nimmo occur in India. M. oleifera (the drumstick tree, horse radish tree, West Indian Ben) is a fast-growing, medium sized and drought-resistant tree distributed in the sub-Himalayan tracts of northern India (Singh et al. 2000; Hsu et al. 2006). The species of Moringa are further discussed in Bennet, R. N., Mellon, F. A., Foidl, N., Pratt, J. H., DuPont, M. S., Perkins, L., and Kroon, P. A. (2003) “Profiling gluconsinolates and phenolics in vegetative and reproductive tissues of the multi-purpose trees, Moringa oleifera L. (horseradish tree) and Moringa stenopetalia L.” Journal of Agricultural and Food Chemistry 51(12) 3546-3553. M. oleifera (locally called shobhanjana, murungai, soanjna, shajna, sainjna) is considered to be the best known and widely distributed tree species among the genus (Morton 1991; Fuglie 1999). This is the only species in this genus which has been accorded some research and development at the world level.

For completeness, the current known species of the plant family Moringaceae are Moringa arborea Verdc. (Kenya), Moringa borziana Mattei, Moringa concanensis Nimmo. Moringa drouhardii Jum.—Bottle Tree (southwestern Madagascar), Moringa hildebrandtii Engl.—Hildebrandt's Moringa (southwestern Madagascar), Moringa longituba Engl., Moringa oleifera Lam. (syn. M. pterygosperma)—Horseradish Tree (northwestern India), Moringa ovalifolia Dinter & Berger, Moringa peregrina (Forssk.) Fiori, Moringa pygmaea Verdc., Moringa ruspoliana Engl., Moringa rivae (Kenya, Ethiopia and Somalia) and Moringa stenopetala (Baker f.) Cufod.

In a preferred aspect the Moringa is a plant of the species Moringa oleifera.

### Mono or Di Ester of Glycerol and Moringa Oil

The process for making mono or di esters of fatty acids and glycerol, in other words mono and diglycerides and the process for making distilled monoglycerides are well known to the person skilled in the art. For example information can be found in “Emulsifiers in Food Technology”, Blackwell Publishing, edited by R. J. Whitehurst, page 40-58.

Mono- and diglycerides are generally produced by interesterification (glycerolysis) of triglycerides with glycerol, see FIG. below:

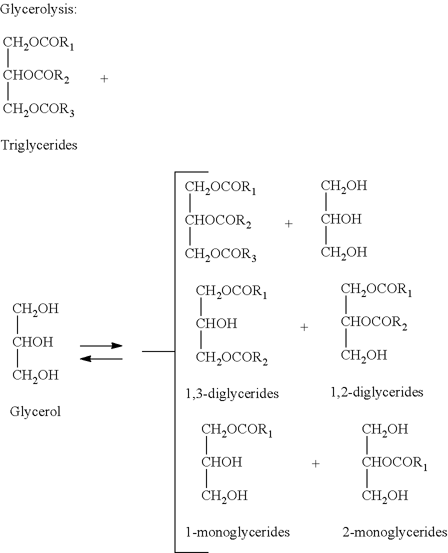

Triglycerides react with glycerol at high temperature (200-250° C.) under alkaline conditions, yielding a mixture of monoglycerides, diglycerides and triglycerides as well as unreacted glycerol. The content of monoglycerides vary typically from 10-60% depending on the glycerol/fat ratio. Alternatively mono- and diglycerides may also be prepared via direct esterification of glycerol with a fatty acid mixture.

If glycerol is removed from the mixture above by e.g. distillation, the resulting mixture of monoglycerides, diglycerides and triglycerides is often sold as a “mono-diglyceride” and used as such. Distilled monoglyceride may be separated from the mono-diglyceride by molecular or short path distillation.

### Usage

The mono or di ester of glycerol and Moringa oil may be provided in the low fat spread in the desired amount to achieve the desired function of the mono or di ester of glycerol and Moringa oil.

In one embodiment, mono or di ester of glycerol and Moringa oil is present in the low fat spread in an amount of at least about 0.01% w/w based on the total weight of the low fat spread. In one embodiment, mono or di ester of glycerol and Moringa oil is present in the low fat spread in an amount of at least about 0.02% w/w based on the total weight of the low fat spread. In one embodiment, mono or di ester of glycerol and Moringa oil is present in the low fat spread in an amount of at least about 0.03% w/w based on the total weight of the low fat spread. In one embodiment, mono or di ester of glycerol and Moringa oil is present in the low fat spread in an amount of at least about 0.04% w/w based on the total weight of the low fat spread. In one embodiment, mono or di ester of glycerol and Moringa oil is present in the low fat spread in an amount of at least about 0.05% w/w based on the total weight of the low fat spread. In one embodiment, mono or di ester of glycerol and Moringa oil is present in the low fat spread in an amount of at least about 0.075% w/w based on the total weight of the low fat spread. In one embodiment, mono or di ester of glycerol and Moringa oil is present in the low fat spread in an amount of at least about 0.1% w/w based on the total weight of the low fat spread. In one embodiment, mono or di ester of glycerol and Moringa oil is present in the low fat spread in an amount of at least about 0.12% w/w based on the total weight of the low fat spread. In one embodiment, mono or di ester of glycerol and Moringa oil is present in the low fat spread in an amount of at least about 0.15% w/w based on the total weight of the low fat spread. In one embodiment, mono or di ester of glycerol and Moringa oil is present in the low fat spread in an amount of at least about 0.2% w/w based on the total weight of the low fat spread. In one embodiment, mono or di ester of glycerol and Moringa oil is present in the low fat spread in an amount of at least about 0.25% w/w based on the total weight of the low fat spread.

In one embodiment, mono or di ester of glycerol and Moringa oil is present in the low fat spread in an amount of from about 0.01 to about 10.0% w/w based on the total weight of the low fat spread. In one embodiment, mono or di ester of glycerol and Moringa oil is present in the low fat spread in an amount of from about 0.01 to about 8.0% w/w based on the total weight of the low fat spread. In one embodiment, mono or di ester of glycerol and Moringa oil is present in the low fat spread in an amount of from about 0.01 to about 7.0% w/w based on the total weight of the low fat spread. In one embodiment, mono or di ester of glycerol and Moringa oil is present in the low fat spread in an amount of from about 0.01 to about 5.0% w/w based on the total weight of the low fat spread. In one embodiment, mono or di ester of glycerol and Moringa oil is present in the low fat spread in an amount of from about 0.01 to about 1.8% w/w based on the total weight of the low fat spread. In one embodiment, mono or di ester of glycerol and Moringa oil is present in the low fat spread in an amount of from about 0.01 to about 1.5% w/w based on the total weight of the low fat spread. In one embodiment, mono or di ester of glycerol and Moringa oil is present in the low fat spread in an amount of from about 0.05 to about 1.5% w/w based on the total weight of the low fat spread. In one embodiment, mono or di ester of glycerol and Moringa oil is present in the low fat spread in an amount of from about 0.075 to about 1.5% w/w based on the total weight of the low fat spread. In one embodiment, mono or di ester of glycerol and Moringa oil is present in the low fat spread in an amount of from about 0.1 to about 1.5% w/w based on the total weight of the low fat spread. In one embodiment, mono or di ester of glycerol and Moringa oil is present in the low fat spread in an amount of from about 0.1 to about 1.2% w/w based on the total weight of the low fat spread. In one embodiment, mono or di ester of glycerol and Moringa oil is present in the low fat spread in an amount of from about 0.15 to about 1.2% w/w based on the total weight of the low fat spread.

In one embodiment mono or di ester of glycerol and Moringa oil is present in the low fat spread in an amount of from about 0.15 to about 10.0% w/w based on the total weight of the low fat spread. In one embodiment, mono or di ester of glycerol and Moringa oil is present in the low fat spread in an amount of from about 0.15 to about 8.0% w/w based on the total weight of the low fat spread. In one embodiment, mono or di ester of glycerol and Moringa oil is present in the low fat spread in an amount of from about 0.15 to about 7.0% w/w based on the total weight of the low fat spread. In one embodiment, mono or di ester of glycerol and Moringa oil is present in the low fat spread in an amount of from about 0.15 to about 6.0% w/w based on the total weight of the low fat spread. In one embodiment, mono or di ester of glycerol and Moringa oil is present in the low fat spread in an amount of from about 0.15 to about 5.0% w/w based on the total weight of the low fat spread. In one embodiment, mono or di ester of glycerol and Moringa oil is present in the low fat spread in an amount of from about 0.15 to about 4.0% w/w based on the total weight of the low fat spread. In one embodiment, mono or di ester of glycerol and Moringa oil is present in the low fat spread in an amount of from about 0.15 to about 3.0% w/w based on the total weight of the low fat spread. In one embodiment, mono or di ester of glycerol and Moringa oil is present in the low fat spread in an amount of from about 0.15 to about 2.0% w/w based on the total weight of the low fat spread. In one embodiment, mono or di ester of glycerol and Moringa oil is present in the low fat spread in an amount of from about 0.15 to about 1.5% w/w based on the total weight of the low fat spread. In one embodiment, mono or di ester of glycerol and Moringa oil is present in the low fat spread in an amount of from about 0.15 to about 1.2% w/w based on the total weight of the low fat spread. In one embodiment, mono or di ester of glycerol and Moringa oil is present in the low fat spread in an amount of from about 0.15 to about 1.0% w/w based on the total weight of the low fat spread. In one embodiment, mono or di ester of glycerol and Moringa oil is present in the low fat spread in an amount of from about 0.15 to about 0.8% w/w based on the total weight of the low fat spread. In one embodiment, mono or di ester of glycerol and Moringa oil is present in the low fat spread in an amount of from about 0.15 to about 0.6% w/w based on the total weight of the low fat spread. In one embodiment, mono or di ester of glycerol and Moringa oil is present in the low fat spread in an amount of from about 0.15 to about 0.4% w/w based on the total weight of the low fat spread.

### Low Fat Spread

In addition to providing a low fat spread containing a mono or di ester of glycerol and Moringa oil, the present invention provides a process for preparing the low fat spread. Thus there is provided a process for preparing a foodstuff in the form of a spread, wherein the spread comprises triglycerides in an amount of less than 41 wt % based on the foodstuff, comprising the steps of (a) contacting (i) a fat phase; and (ii) an aqueous phase; (b) forming an emulsion wherein the fat phase provides a continuous phase and wherein the aqueous phase provides a dispersed phase; and (c) contacting the fat phase and the aqueous phase either before step (b) or after step (b) with a mono or di ester of glycerol and Moringa oil. The emulsion may be a single emulsion, a water in oil emulsion, or the emulsion may be a double emulsion, an oil in water in oil emulsion.

As discussed above it has been found that the present invention is particularly advantageous because the mono or di ester of glycerol and Moringa oil has particular advantages in respect of the stability of emulsions formed by its use as an emulsifier. The present applicants have surprisingly found that an emulsion prepared using the Moringa mono and di glycerides may be sufficiently stable to be used in demanding application but which is not overly stable. Thus if it is desired, the emulsion may be separated into its component phases. Thus in a further aspect the present invention provides use of a mono or di ester of glycerol and Moringa oil to prepare a food or feed emulsion wherein the emulsion may be separated into its constituent phases.

In the process of the present invention the mono or di ester of glycerol and Moringa oil may be added to the (i) fat phase; and (ii) aqueous phase by addition any suitable route For example the mono or di ester of glycerol and Moringa oil may be added to one or both of the (i) fat phase; and (ii) aqueous phase prior to the contact of the (i) fat phase; and (ii) aqueous phase and thereby be present on contact of the (i) fat phase; and (ii) aqueous phase. Alternatively, the mono or di ester of glycerol and Moringa oil may be added to the (i) fat phase; and (ii) aqueous phase once they have been combined or as they are combined. In one aspect the mono or di ester of glycerol and Moringa oil is present in the fat phase of step (a).

As discussed herein, the spread contains triglycerides in an amount of less than 41 wt % based on the foodstuff. Such a spread is commonly referred to as a low fat spread. In one aspect, the spread contains triglycerides in an amount of less than 40 wt % based on the foodstuff. In one aspect, the spread contains triglycerides in an amount of less than 35 wt % based on the foodstuff. In one aspect, the spread contains triglycerides in an amount of less than 30 wt % based on the foodstuff. In one aspect, the spread contains triglycerides in an amount of less than 25 wt % based on the foodstuff. In one aspect, the spread contains triglycerides in an amount of less than 20 wt % based on the foodstuff. In one aspect, the spread contains triglycerides in an amount of less than 15 wt % based on the foodstuff. In one aspect, the spread contains triglycerides in an amount of less than 10 wt % based on the foodstuff. In one aspect, the spread contains triglycerides in an amount of less than 5 wt % based on the foodstuff.

As discussed herein, the spread contains triglycerides in an amount of less than 41 wt. % based on the foodstuff. Such a spread is commonly referred to as a low fat spread. In one aspect, the spread contains triglycerides in an amount of from 10 to less than 41 wt. % based on the foodstuff. In one aspect, the spread contains triglycerides in an amount of from 15 to less than 41 wt. % based on the foodstuff. In one aspect, the spread contains triglycerides in an amount of from 20 to less than 41 wt. % based on the foodstuff. In one aspect, the spread contains triglycerides in an amount of from 25 to less than 41 wt. % based on the foodstuff. In one aspect, the spread contains triglycerides in an amount of from 28 to less than 41 wt. % based on the foodstuff. In one aspect, the spread contains triglycerides in an amount of from 30 to less than 41 wt. % based on the foodstuff. In one aspect, the spread contains triglycerides in an amount of from 35 to less than 41 wt. % based on the foodstuff.

In respect of double emulsions the present invention is further advantageous because long chain fatty acids and/or essential oils present in the double emulsion are effectively encapsulated by the emulsion provided by the Moringa monoglyceride. This degree of encapsulation protects the long chain fatty acids and/or essential oils from degradation. Yet further, we have found that the because of the high affinity of the Moringa monoglyceride for water, similar to the high affinity shown by polyglycerol polyricinoleic acid (PGPR) for water, the Moringa monoglyceride can exhibit PGPR like properties in double emulsions, for example the Moringa monoglyceride may protect salt and the like held within an internal water phase.

### Polyglycerol Polyricinoleic Acid (PGPR)

The present inventors have identified that the mono or di ester of glycerol and Moringa oil has a significant number of emulsifying properties similar to that of polyglycerol polyricinoleic acid and in particular is similar in respect of interfacial properties. This is despite the two materials being structurally very dissimilar. For this reason at least the finding of the similarity in properties was extremely surprising. These properties may be studied by tensiometry and are discussed in detail herein. Therefore in aspects of the invention the present emulsifier may be used to replace PGPR in low fat spreads where PGPR is typically used. This replacement may be complete replacement or partial replacement. In respect of partial replacement, in that aspect the present invention provides a foodstuff in the form of a spread, wherein the spread is a water in oil emulsion containing (a) a continuous fat phase (b) a dispersed aqueous phase, wherein the spread comprises (i) triglycerides in an amount of less than 41 wt % based on the foodstuff (ii) a mono or di ester of glycerol and Moringa oil; and (iii) polyglycerol polyricinoleic acid.

The use of Moringa monoglycerides in food applications could lead to significant benefits for the customer if these monoglycerides can be used to partially or completely replace polyglycerol polyricinoleic acid (PGPR) based products. Such benefits would likely include; improved production yield (attributed to less down time), allow re-work to occur more easily, and potentially enable the removal of E476 from labelling. It is not clear which of these benefits is most attractive to the customer, but each represents a significant advantage.

### Polyglycerols

Polyglycerols are substances consisting of oligomer ethers of glycerol. Polyglycerols are usually prepared from an alkaline polymerisation of glycerol at elevated temperatures.

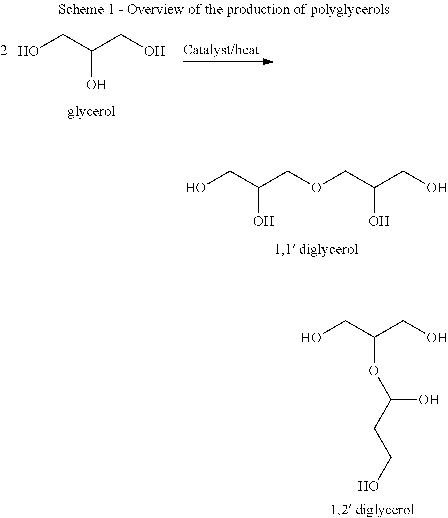 [SMILES: OCC(O)CO ; OCC(O)COCC(O)CO ; OCCC(O)OC(CO)CO]

The processes for making polyglycerols are well known to the person skilled in the art and can be found, for example, in “Emulsifiers in Food Technology”, Blackwell Publishing, edited by R J Whithurst, page 110 to 130.

It will be understood that the degree of polymerisation can vary. It will be understood that the degree of polymerisation can vary. It will be understood that polyglycerol is typically a mixture of polyglycerols of varying degrees of polymerisation. In one embodiment, the polyglycerol used to form the polyglycerol ester of a polymerised fatty acid is a mixture of polyglycerols selected from diglycerol, triglycerol, tetraglycerol, pentaglycerol, hexaglycerol, heptaglycerol, octaglycerol, nonaglycerol and decaglycerol. In one preferred embodiment triglycerol is the most abundant polyglycerol in the mixture of polyglycerols. In one preferred embodiment tetraglycerol is the most abundant polyglycerol in the mixture of polyglycerols. In one preferred embodiment the mixture of polyglycerols contains triglycerol in an amount of 30-50 wt % based on the total weight of polyglycerols and contains tetraglycerol in an amount of 10-30 wt % based on the total weight of polyglycerols.

In one embodiment, the polyglycerol is considered to be a diglycerol. In one embodiment, the polyglycerol is considered to be a triglycerol. In one embodiment, the polyglycerol is considered to be a tetraglycerol. In one embodiment, the polyglycerol is considered to be a pentaglycerol. In one embodiment, the polyglycerol is considered to be a hexaglycerol. In one embodiment, the polyglycerol is considered to be a heptaglycerol. In one embodiment, the polyglycerol is considered to be an octaglycerol. In one embodiment, the polyglycerol is considered to be a nonaglycerol. In one embodiment, the polyglycerol is considered to be a decaglycerol.

Preferably the polyglycerol is considered to be a triglycerol. Preferably the polyglycerol is considered to be a tetraglycerol.

In one embodiment, the polyglycerol moiety shall be composed of not less than 75% of di-, tri- and tetraglycerols and shall contain not more than 10% of polyglycerols equal to or higher than heptaglycerol.

Polyglycerols may be linear, branched or cyclic in structure. Typically, all three types of polyglycerol structure are present in the composition of the present invention.

### Fatty Acids

Fatty acids are well known in the art. They typically comprise an “acid moiety” and a “fatty chain”. The properties of the fatty acid can vary depending on the length of the fatty chain, its degree of saturation, and the presence of any substituents on the fatty chain. Examples of fatty acids are palmitic acid, stearic acid, oleic acid, and ricinoleic acid.

The fatty acid used according to this aspect of the present invention is ricinoleic acid.

Ricinoleic acid is a chiral molecule. Two steric representations of ricinoleic acid are given below:

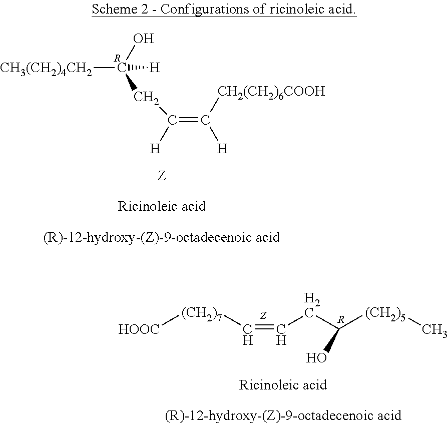

The ricinoleic acid used in the present invention may be prepared by any suitable means known to the person skilled in the art. Typically, fatty acids are produced from a parent oil via hydrolyzation and distillation.

### BRIEF DESCRIPTION OF FIGURES

FIGS. 1 to 3 show images;

FIGS. 4 and 5 show graphs,

FIGS. 6 to 8 show images;

FIGS. 9 to 11 show graphs;

FIGS. 12 to 15 show images;

FIGS. 16 to 18 show graphs,

FIGS. 19 and 20 show images, and

FIG. 21 shows a graph.

### EXAMPLES

The present invention will now be defined with reference to the following non-limiting examples.

### Materials & Methods

The Moringa monoglyceride and distilled Moringa monoglyceride were prepared in several batches in accordance with the processes described below.

2472/173: Mono-Diglyceride Based on Moringa Oil. Interesterification.

### (Mono-diglyceride 173; Moringa Mono-diglyceride 173; Moringa 173; MM 173)

Refined moringa oil (Code: 126089, Batch Nr: DE05040243, EO Ref: SO4903823/1, from Earth Oil Plantations Limited). 2550 g. The moringa oil was extracted from Moringa oleifera (also known as Moringa pterygosperma).

### Glycerol 625 g.

1.300 g 50% solution of NaOH.

Above ingredients were charged to a 5 L 3-necked round bottomed flask, with mechanical stirring, heating mantel with temperature control, nitrogen blanketing, condenser, in a set-up analogous to the below example:

The temperature was raised to 240° C. under stirring and nitrogen blanketing. The mixture was heated at 240° C. until it becomes clear. When clear, the mixture was heated for further 30 min.

The mixture was then neutralised with 1.25 g H₃PO₄ (85%) at 240° C. After neutralisation the mixture was cooled to about 90° C.

The mixture as deodorised in order to remove the free glycerol. The set-up around the 3-necked flask was therefore changed to look like the below example of a deodorisation set-up:

Water vapours were introduced to the mixture via a glass tube at the bottom of the 3 necked flask below surface level of the mixture, a cold trap cooled by acetone/CO₂ bath was used and connected to a vacuum pump.

At 90° C. full vacuum (<0.5 mm Hg) was supplied to the set-up from the vacuum pump. This caused thorough mixing of the product mixture. Then the mixture was heated to 140° C. and kept at this temperature for 30 min. Water vapours were passing through the mixture thereby removing free glycerol which was condensed on the cold trap and collected in the receiver flask.

After 30 min the product was cooled to 90° and pressure equalised with nitrogen.

Optionally the filtered mono-diglyceride can be protected with antioxidants if the mono-diglyceride is the end product. Antioxidants were added and the mixture stirred for 15-30 min under nitrogen blanketing at 80-90° C.

Yield 2870 g.

The mono-diglyceride was filtered through filtered (Clarcell) and paper filter (AGF 165-110).

### 2472/191: Distilled Monoglyceride Based on Moringa Oil.

### (Mono-Diglyceride 191; Moringa Mono-Diglyceride 191; Moringa 191; MM 191)

Mono-diglyceride (2472/173) 2480 g.

The mono-diglyceride was distilled on a short path distillation apparatus.

The distillation temperature was 210° C.

Reservoir temp. before heated surface 85° C.

Condenser was 85° C.

Rotor speed 302 rpm.

Pressure: 1×10⁻³ mBar

Distillate 1373 g

Residue 1107 g

Time 212 min.

Flow: 701 g/h

The distillate as added antioxidant Grindox 349 0.68 g.

### Analysis of the Distilled Monoglyceride Determined by GC:

TABLE 1
composition of monoglyceride based on moringa oil

| | % |
|---|---|
| Glycerol | 0.76 |
| Diglycerol | 0.07 |
| Monoglyceride | 91.15 |
| Diglyceride | 7.75 |
| Triglyceride | 0.00 |

The fatty acid composition of both the starting material, moringa oil, and the resulting monoglyceride was also analysed:

TABLE 2
Fatty acid composition of moringa oil and
the resulting monoglyceride.

| | Triglyceride | Monoglyceride |
|---|---|---|
| | (moringa oil) | 2472/191 |
| C12 | 0.2 | <0.1 |
| C14 | 0.1 | 0.1 |
| C15 | <0.1 | <0.1 |
| C16 | 5.9 | 6.5 |
| C16:1 | 1.8 | 1.8 |
| C18 | 5.5 | 5.8 |
| C18:1 | 71.8 | 71.2 |
| C18:2 | 1.6 | 1.5 |
| C18:3 | 0 | 0.3 |
| C20 | 3.3 | 3.4 |
| C20:1 | 1.9 | 1.9 |
| C22 | 6.3 | 6.0 |
| C24 | 1.0 | 0.8 |

This analysis was done in order to confirm that the fatty acid composition of the monoglyceride had not changed too much from the starting material.

Moringa oil contains 10-12% of saturated fatty acids above C18. In order to keep these high melting fatty acids in the distilled monoglyceride the distillation temperature had to be chosen sufficiently high such that these at least were distilled. As can be seen from the above table this was accomplished. Transferring the highest boiling monoglyceride components however results in the monoglyceride as such having a higher content of diglyceride than is usually seen with distilled monoglycerides, but that is merely a consequence of the broad fatty acid composition in the moringa oil, and that the heavier monoglycerides were prioritised due to their also higher melting points.

2559/102: Mono-Diglyceride Based on Moringa Oil. Interesterification.

### (Mono-Diglyceride 102; Moringa Mono-Diglyceride 102; Moringa 102; MM 102)

Refined moringa oil (Code: 126089, Batch Nr: DE05040243, EO Ref: SO4903823/1, from Earth Oil Plantations Limited). 2072 g.

Glycerol 518 g

1.082 g 50% solution of NaOH

The experiment was carried out as for above interesterification (2472/173).

After the interesterification, the mixture was neutralised with 1.04 g H₃PO₄ (85%) at 240° C. After neutralisation the mixture was cooled to about 90° C. and the mixture was deodorised and filtered as for above interesterification (2472/173).

Yield: 2313 g.

### Analysis of Mono-Diglyceride:

TABLE 3
Composition of mono-diglyceride based on moringa oil

| | % |
|---|---|
| Glycerol | 0.11 |
| Diglycerol | 0.05 |
| Free fatty acids | 0.2 |
| Monoglyceride | 53.16 |
| Diglyceride | 42.05 |
| Triglyceride | 4.39 |

2559/103: Mono-Diglyceride Based on Moringa Oil. Interesterification

### (Mono-Diglyceride 103; Moringa Mono-Diglyceride 103; Moringa 103; MM 103)

### (Repetition of 2559/102)

Refined moringa oil (Code: 126089, Batch Nr: DE05040243, EO Ref: SO4903823/1, from Earth Oil Plantations Limited). 2146 g.

Glycerol 537 g

1.110 g 50% solution of NaOH

The experiment was carried out as for above interesterification (2472/173).

After the interesterification, the mixture was neutralised with 1.07 g H₃PO₄ (85%) at 240° C. After neutralisation the mixture was cooled to about 90° C. and the mixture was deodorised and filtered as for above interesterification (2472/173).

Yield: 2412 g.

### Analysis of Mono-Diglyceride:

TABLE 4
Composition of mono-diglyceride based on moringa oil

| | % |
|---|---|
| Glycerol | 0.16 |
| Diglycerol | 0.02 |
| Free fatty acids | 0.3 |
| Monoglyceride | 54.85 |
| Diglyceride | 39.59 |
| Triglyceride | 5.06 |

### 2559/104: Distilled Monoglyceride Based on Moringa Oil.

### (Mono-Diglyceride 104; Moringa Mono-Diglyceride 104; Moringa 104; MM 104)

The mono-diglyceride was distilled on a short path distillation apparatus as above (2472/191).

Mono-diglyceride (2559/102) (2559/103) were both distilled.

The distillation temperature was 200-210° C.

Reservoir temp. before heated surface 85° C.

Condenser was 90° C.

Rotor speed 297 rpm.

Pressure: 4-5×10⁻³ mBar

Distillate 2245 g

Residue 1819 g

Time 360 min.

Flow: 677 g/h

### Analysis of Distilled Monoglyceride Determined by GC:

TABLE 5
Composition of monoglyceride based on moringa oil

| | % |
|---|---|
| Glycerol | 1.27 |
| Diglycerol | 0.08 |
| Free fatty acids | 0.4 |
| Monoglyceride | 82.55 |
| Diglyceride | 15.67 |
| Triglyceride | 0.02 |

2559/105: Distilled Monoglyceride Above Based on Moringa Oil with Added Antioxidant.

### (Mono-Diglyceride 105; Moringa Mono-Diglyceride 105; Moringa 105; MM 105)

2559/104: 2245 g

Grindox 349: 1.12 g

### 2559/132: Distilled Monoglyceride Based on Moringa Oil.

### (Mono-Diglyceride 132; Moringa Mono-Diglyceride 132; Moringa 132; MM 132)

Mono-diglyceride prepared analogously to above mono-diglycerides (2472/173) and with the following analysis were used as raw material for the distillation.

TABLE 6
Composition of mono-diglyceride used as
raw material for distillation.

| | % |
|---|---|
| Glycerol | 0.16 |
| Diglycerol | 0.13 |
| Free fatty acids | 0.2 |
| Monoglyceride | 55.39 |
| Diglyceride | 39.50 |
| Triglyceride | 4.65 |

The mono-diglyceride was distilled on a short path distillation apparatus as above (2472/191).

The distillation temperature was 210° C.

Reservoir temp. before heated surface 85° C.

Condenser was 85° C.

Rotor speed 297 rpm.

Pressure: 1-2×10⁻³ mBar

Distillate 1506 g

Residue 1092 g

Time 211 min.

Flow: 739 g/h

### Analysis of Distilled Monoglyceride Determined by GC:

TABLE 7
Composition of monoglyceride based on moringa oil

| | % |
|---|---|
| Glycerol | 0.88 |
| Diglycerol | 0.15 |
| Free fatty acids | 0.2 |
| Monoglyceride | 86.92 |
| Diglyceride | 11.80 |
| Triglyceride | 0.03 |

### 2559/134: Distilled Monoglyceride Based on Moringa Oil.

### (Mono-Diglyceride 134; Moringa Mono-Diglyceride 134; Moringa 134; MM 134)

Mono-diglyceride prepared analogously to above mono-diglycerides (2472/173) and with the following analysis were used as raw material for the distillation.

TABLE 8
Composition of mono-diglyceride used as
raw material for distillation.

| | % |
|---|---|
| Glycerol | 0.49 |
| Diglycerol | 0.11 |
| Free fatty acids | 0.2 |
| Monoglyceride | 54.51 |
| Diglyceride | 39.78 |
| Triglyceride | 4.92 |

The mono-diglyceride was distilled on a short path distillation apparatus as above (2472/191).

The distillation temperature was 185° C.

Reservoir temp. before heated surface 85° C.

Condenser was 85° C.

Rotor speed 290 rpm.

Pressure: 1-2×10⁻³ mBar

Distillate 1407 g

Residue 1444 g

Time 223 min.

Flow: 767 g/h

### Analysis of Distilled Monoglyceride Determined by GC:

TABLE 9
Composition of monoglyceride based on moringa oil.

| | % |
|---|---|
| Glycerol | 0.52 |
| Diglycerol | 0.22 |
| Free fatty acids | 0.2 |
| Monoglyceride | 97.98 |
| Diglyceride | 1.06 |
| Triglyceride | 0.02 |

A summary of the analyses of samples 2559/132 and 2559/134 is given in Table 10 below.

TABLE 10

| | Monoglyceride | Monoglyceride | Triglyceride |
|---|---|---|---|
| | 2559/132 | 2559/134 | starting material |
| Distillation ° C. | 210° C. | 185° C. | |
| GL | 0.88 | 0.52 | |
| DIGL | 0.15 | 0.22 | |
| FFA | 0.2 | 0.2 | |
| MONO | 86.92 | 97.95 | |
| DI | 11.80 | 1.06 | |
| TRI | 0.03 | 0.02 | |
| C12 | <0.1 | <0.1 | 0.2 |
| C14 | 0.1 | 0.1 | 0.1 |
| C16 | 6.3 | 6.4 | 5.9 |
| C16:1 | 1.9 | 1.9 | 1.8 |
| C17 | 0.1 | 0.1 | 0.1 |
| C18 | 5.5 | 5.7 | 5.5 |
| C18:1 | 72.6 | 75.3 | 71.8 |
| C18:2 | 1.5 | 1.5 | 1.6 |
| C18:3 | 0.2 | 0.2 | 0.0 |
| C20 | 3.2 | 2.9 | 3.3 |
| C20:1 | 1.8 | 1.7 | 1.9 |
| C20:u | 0.2 | 0.2 | 0.1 |
| C21 | <0.1 | 0.0 | |
| C22 | 5.8 | 3.6 | 6.3 |
| C22:1 | 0.1 | 0.0 | 0.1 |
| C23 | <0.1 | <0.1 | 1.0 |
| C24 | 0.8 | 0.3 | 0.1 |

2461/206: Mono-Diglyceride Based on Moringa Oil. Interesterification.

Refined moringa oil (Code: 126089, Batch Nr: DE05040243, EO Ref: SO4903823/1, from Earth Oil Plantations Limited). 3000 g.

Glycerol 750 g

1.08 g 50% solution of NaOH

The experiment was carried out as for above interesterification (2472/173).

After the interesterification, the mixture was neutralised with 5.65 g H₃PO₄ (10%) in glycerol at 240° C., After neutralisation the mixture was cooled to about 90° C. and the mixture was deodorised and filtered as for above interesterification (2472/173).

Yield: 3751 g.

### Analysis of Mono-Diglyceride:

| | % |
|---|---|
| Glycerol | 0.2 |
| Diglycerol | <0.1 |
| Free fatty acids | 0.2 |
| Monoglyceride | 54.0 |
| Diglyceride | 40.5 |
| Triglyceride | 5.1 |

### Composition of Mono-Diglyceride Based on Moringa Oil

2461/207: Mono-Diglyceride Based on Moringa Oil. Interesterification

### (Repetition of 2461/206)

Refined moringa oil (Code: 126089, Batch Nr: DE05040243, EO Ref: SO4903823/1, from Earth Oil Plantations Limited). 3000 g.

Glycerol 750 g

1.08 g 50% solution of NaOH

The experiment was carried out as for above interesterification (2472/173).

After the interesterification, the mixture was neutralised with 5.65 g H₃PO₄ (10%) in glycerol at 240° C. After neutralisation the mixture was cooled to about 90° C. and the mixture was deodorised and filtered as for above interesterification (2472/173).

Yield: 3751 g.

### Analysis of Mono-Diglyceride:

| | % |
|---|---|
| Glycerol | 0.5 |
| Diglycerol | <0.1 |
| Free fatty acids | 0.3 |
| Monoglyceride | 52.0 |
| Diglyceride | 41.9 |
| Triglyceride | 5.3 |

### Composition of Mono-Diglyceride Based on Moringa Oil

### 2461/208: Distilled Monoglyceride Based on Moringa Oil.

The mono-diglycerides 2461/206+2461/208 were distilled on a short path distillation apparatus as above (2472/191).

The distillation temperature was 210° C.

Reservoir temp. before heated surface 85° C.

Condenser was 80° C.

Rotor speed 300 rpm.

Pressure: 2×10⁻³ mBar

Distillate 3750 g

Residue 2711 g

Time 540 min.

Flow: 718 g/h

### Analysis of Distilled Monoglyceride Determined by GC:

| | % |
|---|---|
| Glycerol | 1.2 |
| Diglycerol | 0.1 |
| Free fatty acids | 0.1 |
| Monoglyceride | 83.5 |
| Diglyceride | 15.2 |
| Triglyceride | 0.1 |

### Composition of Monoglyceride Based on Moringa Oil

The distilled monoglyceride was protected with antioxidant: Grindox 349: 1.87 g

### Example 1

In the present example we demonstrate the difference between a natural non-hydrogenated monoglyceride surfactant based on Moringa (MM), and a fully saturated long chain monoglyceride based on C_{22:0}, (GRINDSTED® CRYSTALLIZER 110), in water in oil low fat emulsions. The results confirm that the addition of fully saturated long chain surfactants alone de-stabilise, whereas the natural non-hydrogenated surfactant whilst still containing proportions of fully saturated long chain fatty acids did not have the propensity for de-stabilisation. However these findings do not negate the advantages of GRINDSTED® CRYSTALLIZER 110 when used as a co-surfactant in low fat water in oil emulsions, or alone in other higher fat containing applications.

Two fat concentrations were studied, 35% and 40%. The recipes of the spreads come from Jr. No. DK17124, and are given in Tables 11 and 12. In the case of the 35% fat samples (Table 11) the water phase is empty, i.e. does not contain hydrocolloid thickeners, whereas in the case of 40% fat spreads (Table 12) the water phase contains GRINDSTED® LFS 560 Stabiliser System. The plant process conditions are subsequently given for the 35% and 40% fat samples in Table 13, and were the same in each case. The specification of Moringa monoglyceride (MM 191) is as given in Table 14. The MM was prepared as described above.

The procedure for processing the recipe is given as follows for all samples shown above:

### Water Phase:

1. Heat water to 80° C.
2. Mix all dry ingredients
3. Slowly add dry ingredients to the water stirring intensively on stirring device for 4 minutes.
4. Cool water phase to 40° C.
5. Re-weigh and add water equivalent to the amount of evaporation
6. Adjust pH with citric acid or NaOH
7. Add flavour just before running the Perfector

TABLE 11
Recipe for low fat spread samples with MM and
GRINDSTED ® CRYSTALLIZER 110 at 35% fat content.
Ingredients in %

| | | | | | | |
|---|---|---|---|---|---|---|
| Ingredient Name | 21 | 22 | 23 | 24 | 25 | 26 |

Water phase

| | | | | | | |
|---|---|---|---|---|---|---|
| Water (Tap) | 64.000 | 64.000 | 64.000 | 64.000 | 64.000 | 64.000 |
| Salt (Sodium | 1.000 | 1.000 | 1.000 | 1.000 | 1.000 | 1.000 |
| Chloride) | | | | | | |
| Butter Flavouring | 0.010 | 0.010 | 0.010 | 0.010 | 0.010 | 0.010 |
| 050001 T03007 | | | | | | |
| Water phase total | 65.010 | 65.010 | 65.010 | 65.010 | 65.010 | 65.010 |
| pH | 5.5 | 5.5 | 5.5 | 5.5 | 5.5 | 5.5 |

Fat phase
Fat blend

| | | | | | | |
|---|---|---|---|---|---|---|
| PK4 - INES | 25.000 | 25.000 | 25.000 | 25.000 | 25.000 | 25.000 |
| COLZAO | 75.000 | 75.000 | 75.000 | 75.000 | 75.000 | 75.000 |
| Fat blend total | 100.000 | 100.000 | 100.000 | 100.000 | 100.000 | 100.000 |

Other fat ingredients

| | | | | | | |
|---|---|---|---|---|---|---|
| (MRF) Moringa, | | 0.150 | | | | 1.200 |
| monoglyceride 191 | | | | | | |
| GRINDSTED ® | 0.150 | | 0.300 | 0.600 | 1.200 | |
| CRYSTALLIZER 110 - K, | | | | | | |
| Destilled Monoglyceride | | | | | | |
| 2% sol. beta-carotene | 0.020 | 0.020 | 0.020 | 0.020 | 0.020 | 0.020 |
| Butter Flavouring | 0.020 | 0.020 | 0.020 | 0.020 | 0.020 | 0.020 |
| 050001 T04184 | | | | | | |
| Other fat | 0.190 | 0.190 | 0.340 | 0.640 | 1.240 | 1.240 |
| ingredients total | | | | | | |
| Fat phase total | 34.990 | 34.990 | 34.990 | 34.990 | 34.990 | 34.990 |
| RECIPE total (calc. | 100.000 | 100.000 | 100.000 | 100.000 | 100.000 | 100.000 |
| batchsize) | | | | | | |

Butter flavour (water phase) 050001 T03007, and Butter flavour (oil phase) 050001 T04184 were obtained from Firmenich, Denmark

PK4-INES is a interesterified mixture of 60% palm stearine and 40% palm kernel available from Cargill GmbH., Hamburg, Germany

COLZAO is a rape seed oil available from AarhusKarlshamn (AAK), Denmark.

TABLE 12
Recipe for low fat spread samples with MM and
GRINDSTED ® CRYSTALLIZER 110 at 40% fat content.
Ingredients in %

| | | | | | | |
|---|---|---|---|---|---|---|
| Ingredient Name | 11 | 12 | 13 | 14 | 15 | 16 |

Water phase

| | | | | | | |
|---|---|---|---|---|---|---|
| Water (Tap) | 57.300 | 57.300 | 57.300 | 57.300 | 57.300 | 57.300 |
| Salt (Sodium | 1.000 | 1.000 | 1.000 | 1.000 | 1.000 | 1.000 |
| Chloride) | | | | | | |
| Skimmed milk | 0.100 | 0.100 | 0.100 | 0.100 | 0.100 | 0.100 |
| powder (MILEX 240) | | | | | | |
| GRINDSTED ® | 1.500 | 1.500 | 1.500 | 1.500 | 1.500 | 1.500 |
| LFS 560 Stabiliser | | | | | | |
| System | | | | | | |
| Potassium Sorbate | 0.100 | 0.100 | 0.100 | 0.100 | 0.100 | 0.100 |
| Butter Flavouring | 0.010 | 0.010 | 0.010 | 0.010 | 0.010 | 0.010 |
| 050001 T03007 | | | | | | |
| Water phase total | 60.010 | 60.010 | 60.010 | 60.010 | 60.010 | 60.010 |
| Ph | 5.5 | 5.5 | 5.5 | 5.5 | 5.5 | 5.5 |

Fat phase
Fat blend

| | | | | | | |
|---|---|---|---|---|---|---|
| PK4 - INES | 25.000 | 25.000 | 25.000 | 25.000 | 25.000 | 25.000 |
| COLZAO | 75.000 | 75.000 | 75.000 | 75.000 | 75.000 | 75.000 |
| Fat blend total | 100.000 | 100.000 | 100.000 | 100.000 | 100.000 | 100.000 |

Other fat ingredients

| | | | | | | |
|---|---|---|---|---|---|---|
| (MRF) Moringa, | 0.150 | | | | | 1.200 |
| monoglyceride 191 | | | | | | |
| GRINDSTED ® | | 0.150 | 0.300 | 0.600 | 1.200 | |
| CRYSTALLIZER 110 - K, | | | | | | |
| Destilled Monoglyceride | | | | | | |
| 2% sol. beta-carotene | 0.020 | 0.020 | 0.020 | 0.020 | 0.020 | 0.020 |
| Butter Flavouring | 0.020 | 0.020 | 0.020 | 0.020 | 0.020 | 0.020 |
| 050001 T04184 | | | | | | |
| Other fat | 0.190 | 0.190 | 0.340 | 0.640 | 1.240 | 1.240 |
| ingredients total | | | | | | |
| Fat phase total | 39.990 | 39.990 | 39.990 | 39.990 | 39.990 | 39.990 |
| RECIPE total (calc. | 100.000 | 100.000 | 100.000 | 100.000 | 100.000 | 100.000 |
| batchsize) | | | | | | |

GRINDSTED® LFS 560 Stabiliser System contains a combination of amidated pectin and sodium alginate, and is obtained from Danisco A/S, Denmark

TABLE 13
Pilot plant processing conditions for the recipe
samples given in Tables 11 and 12.

| Processing (3-tube lab perfector): | |
|---|---|
| Oil phase temperature | 50 |
| Water phase temperature | 50 |
| Emulsion temperature | 50 |
| Centrifugal pump | Auto |
| Capacity high pressure pump | 40 |
| Cooling (NH3) tube 1: | −10 |
| Cooling (NH3) tube 2: | −10 |
| Cooling (NH3) tube 3: | −10 |
| Rpm tube 1: | 1000 |
| Rpm tube 2: | 1000 |
| Rpm tube 3: | 1000 |

### Fat Phase:

1. Weigh out emulsifier, beta carotene (2% solution) and oil/fat in the same container

### 2. Heat to 80° C.

3. Stir the fat phase until mixed well
4. Cool the fat phase to 40° C.
5. Add flavour just before running the Perfector

### Emulsion:

Add the water phase to the fat phase while stirring intensively

Tables 14a and 14b showing fatty acid profiles for MM 191 (Table 14b), and the originating Moringa oil (Table 14b).

TABLE 14a

| Analysis | Moringa oil |
|---|---|
| C14 | 0.1 |
| C15 | <0.1 |
| C16 | 5.8 |
| C16:1 | 1.8 |
| C17 | 0.2 |
| C18 | 5.4 |
| C18:1 | 73.0 |
| C18:2 | 0.7 |
| C18:3 | 0.2 |
| C19 | 0.1 |
| C20 | 3.4 |
| C20:1 | 2.2 |
| C22 | 5.8 |
| C22:1 | 0.1 |
| C24 | 1.0 |
| C26 | — |
| Unknown | 0.2 |

TABLE 14b

| Fatty acid chain length | % present |
|---|---|
| C₁₂ | <0.1 |
| C₁₄ | 0.1 |
| C₁₅ | <0.1 |
| C₁₆ | 6.5 |
| C_{16:1} | 1.8 |
| C₁₇ | 0.2 |
| C₁₈ | 5.8 |
| C_{18:1} | 71.2 |
| C_{18:2} | 1.5 |
| C_{18:3} | 0.3 |
| C₂₀ | 3.4 |
| C_{20:1} | 1.9 |
| C_{20 unsaturated} | 0.3 |
| C₂₂ | 6.0 |
| C_{22 unsaturated} | 0.2 |
| C₂₄ | 0.8 |

The methods of analysis for water droplet size, confocal laser microscopy, and texture analysis were outlined below. Photographic images were recorded by a Canon G12.

### Rheology

### Rotational Rheometer

Investigation of bulk oil blends subjected to the effects of controlled cooling rate while under shear were analysed using a shear stress controlled rotational rheometer Rheometrics SR 5 (proRheo, Germany) controlled stress rheometer operating in simulated rate control mode. Target shear rate of 10 s-1. Crystal history was removed through melting and holding to 90° C. for 15 minutes before loading onto the rheometer. A thermoelectric cooling plate using Peltier effect cooling, with parallel plate geometry (40 mm diameter top plate. Gap=1 mm) and a temperature ramp 70° C. to 25° C. at either 1° C./min, 10° C./min, 30° C./min, was used. A 2 minute delay without shear at 70° C. prior to thermo-cooling was also used.

The fat blend used in all cases comprised of a base of 70% palm stearine (35 IV) and 30% palm olein (56 IV), to which the emulsifiers GRINDSTED® CRYSTALLIZER 110, GRINDSTED® PGPR 90, and Monoglycerides of Moringa were added at 1%, 0.5% and 1% respectively.

### Microscopy

### Polarized Light Microscopy (PLM):

### Introduction:

Polarized light microscopy images are useful to observe effects of environmental conditions on lipid crystallisation behaviour as a consequence of thermal manipulation. The treatment of several emulsions and bulk continuous systems to Isothermal and non-isothermal conditions can provide strong correlations to actual crystallisation behaviour within TAG continuous commercial food systems.

### Method:

Several analyses of W/O emulsions and continuous bulk oil phase systems were observed using an Olympus BX60 optical microscope (Serial no: 6M02546), fitted with polarized filter (Olympus Optical Co. GmbH. Hamburg, Germany). The desired amount of sample (˜40 mg) is placed on a carrier glass slide which has been pre-cooled or preheated to ˜5° C. A cover slip was then placed parallel to the plane of the carrier slide and centred on the drop of sample to ensure uniformity and desirability of sample thickness. The micrograph of the crystal was taken at 40× and 200× magnification unless otherwise indicated. A number of images were acquired each representing a typical field.

### Induction Heat/Cool/Micrograph Images:

Micrograph images were collected in polarised light using a Evolution Color-camera (MP 5.0 RTV 32-0041C-309) supplied from Media Cybernetics (Media Cybernetics, Inc. USA.) attached to the Olympus BX60 optical microscope with following parameters: Heat step 50° C./minute to 80° C., tempering for 2 minutes. Then cool 1° C./minute-10° C./minute-50° C./minute and 100° C./minute to 20° C.

1° C./minute every 30 seconds.

10° C./minute every 10 seconds.

50° C./minute every 3 seconds.

100° C./minute every 3 seconds.

More images were collected at 100° C./min to 20° C., using longer induction time whereby images were taken every 30 seconds for 5 minutes.

### Water Droplet Size Determination

### Droplet Size Distribution in Low-Fat Spread

### Introduction:

One of the important features of an emulsion is its Droplet Size Distribution (DSD). The droplet size influences many characteristics, for instance the rheology (Asano et al 1999; Opedal et al 2009), and the stability of an emulsion (Basheva 1999) and emulsion liquid membrane performance (Chakraborty et al. 2003). Droplet size distribution in low-fat spread is important with respect to appearance, flavour release and microbiological stability. In protein-containing low-fat spreads, stabilisers are added to secure emulsion stability. These also have a profound effect on water droplet size.

### Method:

Pulsed NMR analysis using a pulsed gradient unit Bruker Minispec mq 20, 20 MHz low field pulsed pNMR Analyzer, Magnet unit ND2172, equipped with a Pulsed Gradient Unit 1059. High/low temperature probehead assembly mq-PA231 (−120° C.-+200° C.). Software: SSL, system status logging. CONTIN transformation. Pulsed gradient system for 10 mm tubes (10×180×0.6 mm=diameter×length×thickness). Mq-SOFT EDMs Oil droplets/Water droplets and Diffusio. Bruker gas tempering unit for high and low temperature analysis: mq-BVT3000c (for minispec probe PA231). Measurements are performed at 20° C. and field gradients of 2.0 T/m or higher.

### Analytical Principle:

A Hahn spin echo experiment with field gradient pulses involves calculating the reduction in spin echo amplitude compared with the Hahn spin echo amplitude without field gradient pulses (R).

Determining diffusion coefficient of water molecules If protons can move unhindered in the liquid, then free diffusion is taking place, and the diffusion coefficient D can be determined directly from R.

Determining droplet size distribution in w/o emulsions If proton movement is restricted by the boundaries of a droplet, an R value plateau is obtained reflecting the droplet size.

When measuring at several pulse lengths, the corresponding R plateau values give a fingerprint of the droplet size distribution. Measurements are performed at 5° C. and with 8 R values. Log-normal particle size distribution is typically seen in w/o emulsions and is used in the mathematical calculation of droplet size distribution. Results are given as volume and number size distribution

2.5% of droplet volume is smaller than “x” μm

50% of droplet volume is smaller than “x” μm.

97.5° A of droplet volume is smaller than “x” μm.

and derived from a log-scale using values of the following standardized normal distribution

$$\begin{matrix}2.5 \% < μ & 50 \% < μ & 97.5 \% < μ \\ ( {d}_{lower} ) & ( {d}_{50 , 3} ) & ( {d}_{upper} )\end{matrix}$$

### Interfacial Tension Measurement

Tensiometry Materials and methods

### Solvent

Refined, bleached and deodorized sunflower oil, iodine value 127, was obtained from AAK (Aarhus, Denmark). Purification was then carried out using the following procedure: Mix 30 g of Fluorisil PR60/100 mesh (Sigma-Aldrich Denmark A/S) with 500 g Sunflower Oil in a vessel. The mixture was stirred for 60 min at 80° C., and protected from UV light. After cooling over 12 hrs, the sunflower oil was passed slowly at room temperature through a glass column with filter paper (glass fiber GA55, 47 mm) into 800 ml UV light protected beaker. This procedure results in the sunflower oil having an interfacial tension at 20° C. of 28-30 mN/m (oil-water)

### Preparation of Samples

Oil phase: Emulsifiers were weighed for tensiometer and rheology measurements at 0.02% w/w (unless otherwise indicated) and the RBD sunflower oil balanced to 100%.

The preparation is heated to 10° C. above melting point of emulsifier, and held for 1 hour, then cooled to ambient temperature and deaerated (˜12 hrs). Water phase: Demineralised water is deaerated using a Desiccator (Sigma-Aldrich, Denmark A/S. Copenhagen, Denmark). Both phases are ready to use after heating to 50° C.

### Interfacial Tension

The interfacial tension of oil/water systems was measured on a Digital-Tensiometer, model K10ST (Krüss Germany), using the Wilhelmy plate method, and recorded continuously by connecting a high resolution data recorder (PicoLog ADC-20, using PicoLog for windows 5.13.4 from Pico Technology Ltd, Cambridgeshire. United Kingdom) connected to the tensiometer. A second channel on the recorder was used to monitor the temperature of the oil/water system in the tensiometer. The oil/water phase was controlled by a programmable water bath (model: Thermo Haake® DC10-K10, refrigerated circulator: Sigma-Aldrich, Denmark NS. Copenhagen, Denmark), which allowed the temperature to be changed from 50° C. to 5° C. Prior to initializing measurement the tensiometer K10ST was calibrated for the oil phase to show more than 27 mN/m at 20° C. and held constant for 15 min, enabling both oil and instrument to reach equilibrium constant.

Measurements were started at 50° C. after preheating the oil phase and the water phase to 50° C. separately, Prior to commencing with a temperature sweep, the interfacial tension was measured at 50° C. for 5 minutes to whereby a state of equilibrium between the oil and water phases is thought to be obtained. Then the temperature was decreased to 5° C. at 0.3° C./min and kept at 5° C. for 5 minutes.

### Results & Discussion

TABLE 15
Water droplet size distribution for 35% fat spreads (samples
21-26), and 40% fat spreads (sample 11-16).

| | Average/ | | | |
|---|---|---|---|---|
| Sample ID | St. Dev | 2_5% < μm | 50% < μm | 97_5 % < μm |
| DK 17124-1-11 | Average | 1.08 | 5.38 | 26.80 |
| | St. dev. | 0.02 | 0.07 | 0.54 |
| DK17124-1-12 | Average | 1.10 | 5.62 | 28.80 |
| | St. dev. | 0.05 | 0.03 | 1.14 |
| DK 17124-1-13 | Average | 0.84 | 6.50 | 50.41 |
| | St. dev. | 0.04 | 0.13 | 2.75 |
| DK17124-1-14 | Average | 0.60 | 10.14 | 171.08 |
| | St. dev. | 0.04 | 0.20 | 17.17 |
| DK 17124-1-16 | Average | 2.01 | 3.64 | 6.58 |
| | St. dev. | 0.09 | 0.02 | 0.36 |
| DK 17124-1-21 | Average | 0.23 | 3.46 | 51.73 |
| | St. dev. | 0.01 | 0.07 | 5.26 |
| DK 17124-1-22 | Average | 0.58 | 3.81 | 24.82 |
| | St. dev. | 0.03 | 0.06 | 1.16 |
| DK 17124-1-23 | Average | 0.91 | 10.20 | 115.23 |
| | St. dev. | 0.05 | 0.75 | 21.16 |
| DK 17124-1-24 | Average | 1.01 | 21.66 | 481.56 |
| | St. dev. | 0.05 | 3.66 | 196.53 |
| DK 17124-1-25 | Average | 0.85 | 23.01 | 665.20 |
| | St. dev. | 0.13 | 4.21 | 346.97 |
| DK 17124-1-26 | Average | 3.48 | 3.48 | 3.49 |
| | St. dev. | 0.01 | 0.01 | 0.01 |

The results presented in Table 15 show the water droplet size distribution for the 35% fat spreads (samples 21-26) and the 40% fat spreads (samples 11-16). As will be appreciated from the recipe tables, samples 11, 16, 22 and 26 were in accordance with the present invention. It should be noted that sample DK17124-1-15 could not be measured due to the signal being too weak. Samples DK 17124-1-21, 22, 23, 24, and 26 covering the 35% fat spreads were basically phase separated, with pure liquid in the bottom of the container. Hence, this observation alone indicates that the systems were not stable, but also has a large bearing on the water droplet size results themselves, Thus, the results shown in Table 15 represent an average apparent value on the system. It is also worth stating here that the 35% spreads were made with an empty water phase, i.e. no stabiliser, and therefore these samples represent a spread that has really been stressed. The apparent instability of sample 22 resulted from a combination of a very low Moringa monoglyceride content in an extremely ‘stressed’ system in the absence of any other emulsifier, the use of batch processing (rather than the stability enhancing high shear mixing), and the absence of any further stabilisers. The clear conclusion that is drawn from the results given in Table 15 is that the size of the water droplets for all samples containing GRINDSTED® CRYSTALLIZER 110 are large and therefore the spread samples are prone to instability, and hence separation. This was true irrespective of fat content either 35% or 40%, although the samples at 40% were markedly better.

A different situation was apparent for the samples containing MM. These samples generally showed a stable performance, with the exception of sample 22, which contained MM at 0.15% dosage in the 35% fat spreads. This was the most stressed of the MM containing samples since the water phase of this spread was empty, i.e. no hydrocolloid thickener. Sample 22 was one of the samples which showed phase separation and therefore instability—this was for the reasons described above. However, increasing the dosage up to 1.2% for the same 35% fat spread with empty water phase resulted in a dramatic reduction of the water droplet size, and no phase separation. Here, the presence of the MM was able to stabilise the spread system such that it was able to survive production and storage and stand up to the rigours of spreading. In the 40% fat spreads, with the water phase also stabilised with GRINDSTED® LFS 560 Stabiliser System, MM dosed at 0.15% (sample 11) showed water droplet sizes of 26.8, which was enough to provide a stable emulsion, whereas when the dosage as increased to 1.2% (sample 16) the water droplet size dropped to 6.58, and the level of stability increased.

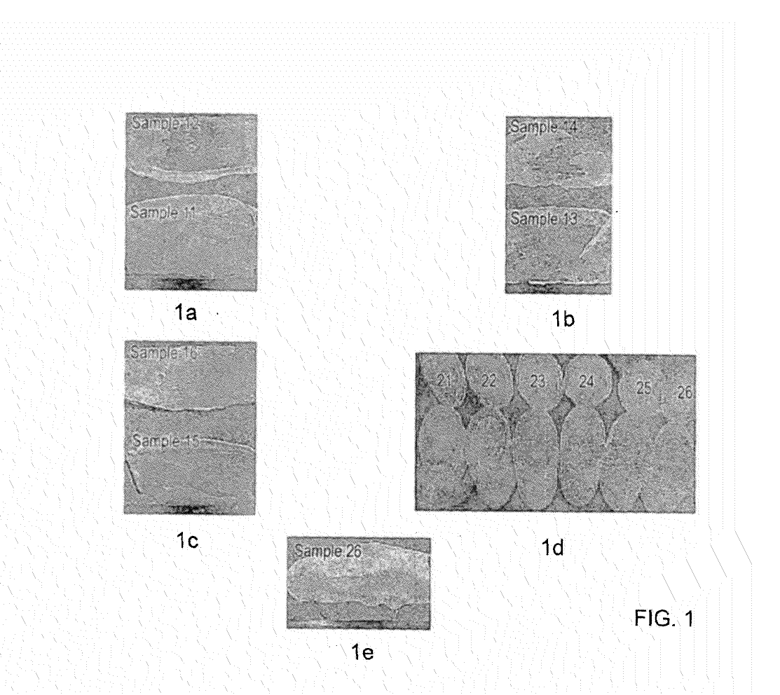

Photographic evidence of the samples after spreading out onto cardboard, and while still in the plastic storage jars highlights the structure present in these spread samples is given in FIG. 1a to 1e. Here the relative stability or breakdown can be readily seen.

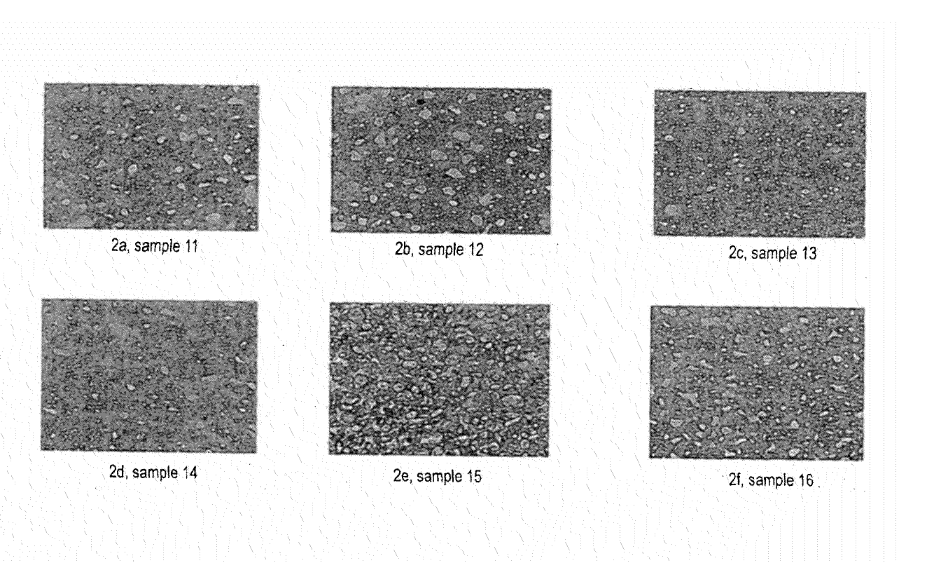

In FIGS. 1a to 1c the spread test on cardboard is seen for the samples at 40% fat content with a stabilised water phase. Sample 11, containing MM at the low dosage of 0.15% produced a thick and creamy emulsion that was stable, and acceptable to spread testing. There was no adverse sign of emulsion breakdown or leakage of water. The next samples (12-15) all contained GRINDSTED® CRYSTALLIZER 110 alone at increasing concentrations from 0.15, 0.3, 0.6 and 1.2% respectively and showed decreasing stability across the concentration gradient. This manifested itself as increasing water release and lumpy structure, until sample 15 was reached which was described as inverted and essentially a flipped oil in water emulsion (notice FIG. 2e). Sample 16 (MM at 1.2%) demonstrated a very thick and stable emulsion, but with very slow flavour release. This indicated that the emulsion here was essentially too stable and that the breakdown profile in the mouth was insufficient to cater for quick flavour release, which is otherwise desired. These results suggest that MM can stabilise in low fat spread applications beyond the capability of GRINDSTED® CRYSTALLIZER 110 molecules, and that the optimum dosage lies between 0.15% and 1.2%. Where additionally PGPR might be added, we have shown that no other emulsifier need be required.

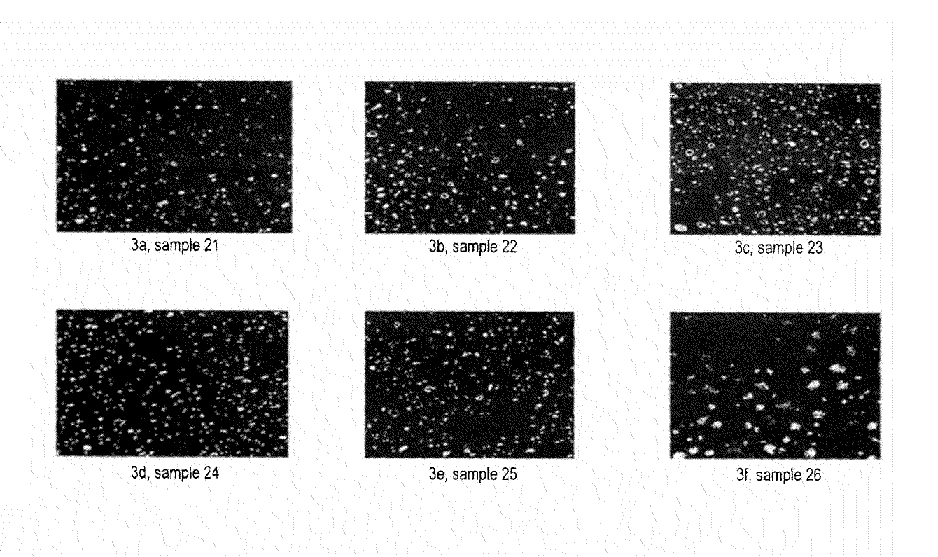

FIG. 1 d shows the samples of the empty water phase at 35% fat content, where all samples are showing signs of breakdown with the exception of sample 26 containing MM at 1.2% dosage. Contrary to the stabilised water phase, here even the sample with MM at 0.15% dosage (sample 22), signs of phase separation and emulsion instability are evident. However, sample 26 did prove to be stable, but was very waxy and had little or no flavour release. One can say that the dosage of MM at 1.2% did stabilise the emulsion. It could be suggested that the CLSM image in FIG. 3e, appears to look unstable. However, this is in fact possibly an artefact of an oil in water in oil emulsion, where MM has reached critical micelle concentration, and formed micelle structures. The fact that it stabilises the emulsion at all highlights that MM has superior properties over those of GRINDSTED® CRYSTALLIZER 110 alone in this highly stressed system. Indeed FIG. 1e shows the results of the spread test for sample 26, and clearly demonstrates the emulsion stability and general spreadability.

The data presented in FIGS. 2a to 2f (samples 11 to 16), and FIGS. 3a to 3f (samples 21 to 26) show the confocal images for the samples of full water phase and a fat content of 40%, and empty water phase and a fat content of 35% respectively.

For FIGS. 2a and 2f, which contain MM at 0.15% and 1.2% respectively, the confocal images show a compact-like water droplet size distribution. This is indicative of a stable emulsion, indeed much as was suggested by the water droplet size distribution measurements and the visual evaluations above. Samples pertaining to FIGS. 2b to 2e show the sample containing GRINDSTED® CRYSTALLIZER 110 at increasing concentration from 0.15%, 0.3%, 0.6% and 1.2% respectively, and basically show the increasing instability of the emulsions until the image corresponding to sample 15 (FIG. 2e) shows complete breakdown.

FIG. 3 with the empty water phase shows the confocal images being too slack to hold the structure together, as indicated from the water droplet size distribution data above, and not least the photographic results of the storage jars. Sample 26 (FIG. 3f) though takes on a different appearance to the others due to the extremely small water droplet size achieved here by MM at 1.2% dosage levels. This emulsion is stable.

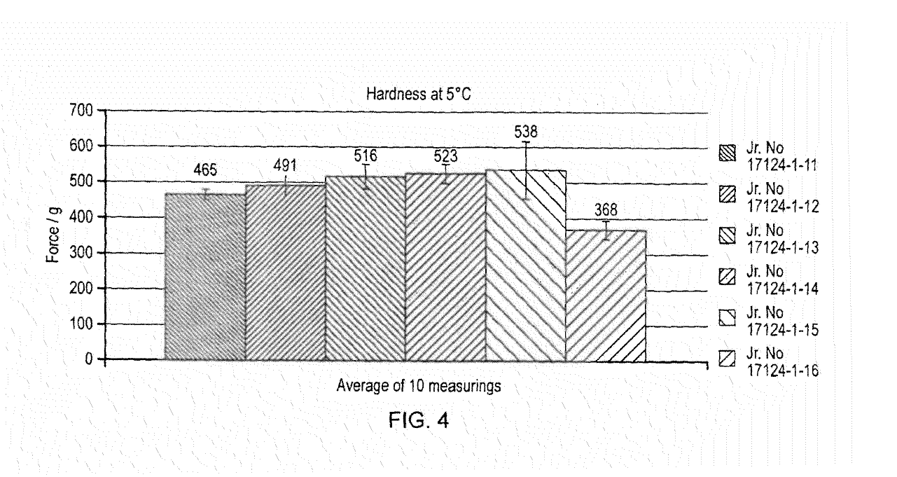

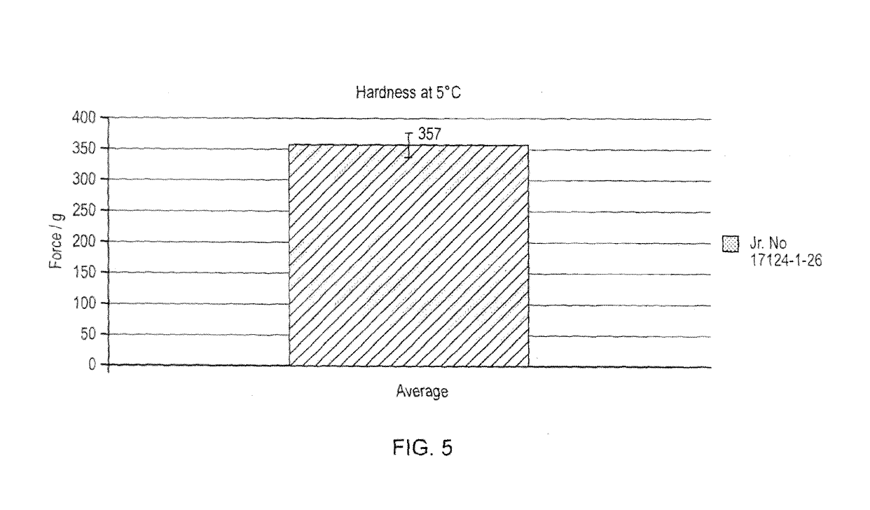

Texture analysis of the spread samples—those that were able to be tested are given in FIGS. 4 and 5. FIG. 4 shows the hardness results for samples 11 to 16, i.e. full water phase, 40% fat content. FIG. 5 shows the hardness results only for sample 26, i.e. MM at 1.2% with the empty water phase and 35% fat content.

An increase in hardness is noted from FIG. 4 in samples 11 to 15, i.e. moving from MM at 0.15% and GRINDSTED® CRYSTALLIZER 110 from 0.15%, 0.3%, 0.6% and 1.2% respectively. The emulsion firmness at the higher crystalliser concentrations is harder and this could be attributed to the continued water leakage from the emulsion making the solid part of the sample appear harder than would otherwise have been. It is worth noting that despite this leakage of water being attributed for the increase in hardness, the level of water leakage has not led to the catastrophic failure of the systems represented in samples 21 to 25. It can be seen that FIG. 5 only has data for one sample, the MM containing Sample 26 at 1.2% dosage. All other samples in this range failed and were not possible to measure. Interestingly, the effect of MM at 1.2% in either the 35% empty water phase or 40% hydrocolloid-protein enriched water phase in a water in oil emulsion gives basically the same force response.

### Conclusion

The results show that low fat spreads cannot be adequately stabilised by GRINDSTED® CRYSTALLIZER 110 alone in either full or empty water phase regimes at 40% or 35% fat content. In each case there is water leakage resulting in breakdown of the emulsion or indeed full scale failure of the emulsion.

In contrast to this, MM were shown to be able to stabilise the emulsions and in the full water phase 40% fat content systems at dosages between 0.15% and 1.2%, with the optimal being in between this range. These systems did not exhibit water leakage, were stable and spreadable. At the high concentration of 1.2%, a tendency towards to over stabilisation resulted, leading to the inability of the emulsion to give good flavour release.

### Example 2

The present example relates to the performance of Monoglycerides of Moringa (MM) at monoglyceride levels of 51.16 and 82.55% respectively in the preparation of commercially viable low fat water in oil emulsion systems. This is confirmed via water droplet size analysis showing smaller water droplets as concentration increases, thereby stability increasing. This is confirmed with confocal laser microscopy images, texture analysis and also photographic images showing the effects of spread testing.

### Materials & Methods

The Moringa monoglyceride and distilled Moringa monoglyceride were prepared in several batches in accordance with the processes described above.

Briefly, the fatty acid profiles of the samples of the monoglyceride from the Moringa is given in Table 16, whereas Table 17 shows the breakdown into mono-, di-, and tri-glycerides.

TABLE 16
Fatty acid composition of natural Moringa monoglyceride.

| Fatty acid chain length | % present |
|---|---|
| C₁₂ | <0.1 |
| C₁₄ | 0.1 |
| C₁₅ | <0.1 |
| C₁₆ | 6.5 |
| C_{16:1} | 1.8 |
| C₁₇ | 0.2 |
| C₁₈ | 5.8 |
| C_{18:1} | 71.2 |
| C_{18:2} | 1.5 |
| C_{18:3} | 0.3 |
| C₂₀ | 3.4 |
| C_{20:1} | 1.9 |
| C_{20 unsaturated} | 0.3 |
| C₂₂ | 6.0 |
| C_{22 unsaturated} | 0.2 |
| C₂₄ | 0.8 |

Table 17 Showing the natural Moringa monoglycerides with the breakdown of mono, di- and tri-glycerides.

| | 2559/102 | 2559/105 |
|---|---|---|
| Glycerol | 0.11 | 1.27 |
| Diglycerol | 0.05 | 0.08 |
| Free fatty acids | 0.2 | 0.4 |
| Monoglycerides | 53.16 | 82.55 |
| Diglycerides | 42.05 | 15.67 |
| Triglycerides | 4.39 | 0.02 |

The recipes used in this report with the samples quoted above can be seen in Table 18, together with the processing parameters for the same in Table 19. The sample overview is given as follows:

| Sample no. | Conc. | Moringa type. |
|---|---|---|
| 41 | 0.15 | Moringa 102 |
| 42 | 0.30 | Moringa 102 |
| 43 | 0.60 | Moringa 102 |
| 44 | 1.20 | Moringa 102 |
| 45 | 0.15 | Moringa 105 |
| 46 | 0.30 | Moringa 105 |
| 47 | 0.60 | Moringa 105 |
| 48 | 1.20 | Moringa 105 |

TABLE 18
Recipes for the low fat W/O emulsions using the natural based MM samples.
Ingredients in %

| | | | | | | | | |
|---|---|---|---|---|---|---|---|---|
| Ingredient Name | 41 | 42 | 43 | 44 | 45 | 46 | 47 | 48 |

Water phase

| | | | | | | | | |
|---|---|---|---|---|---|---|---|---|
| Water (Tap) | 57.300 | 57.300 | 57.300 | 57.300 | 57.300 | 57.300 | 57.300 | 57.300 |
| Salt | 1.000 | 1.000 | 1.000 | 1.000 | 1.000 | 1.000 | 1.000 | 1.000 |
| Skimmed milk | 0.100 | 0.100 | 0.100 | 0.100 | 0.100 | 0.100 | 0.100 | 0.100 |
| powder (MILEX 240) | | | | | | | | |
| GRINDSTED ® | 1.500 | 1.500 | 1.500 | 1.500 | 1.500 | 1.500 | 1.500 | 1.500 |
| LFS 560 | | | | | | | | |
| Potassium Sorbate | 0.100 | 0.100 | 0.100 | 0.100 | 0.100 | 0.100 | 0.100 | 0.100 |
| Butter Flavouring | 0.010 | 0.010 | 0.010 | 0.010 | 0.010 | 0.010 | 0.010 | 0.010 |
| 050001 T03007 | | | | | | | | |
| Water phase total | 60.010 | 60.010 | 60.010 | 60.010 | 60.010 | 60.010 | 60.010 | 60.010 |
| pH | 5.5 | 5.5 | 5.5 | 5.5 | 5.5 | 5.5 | 5.5 | 5.5 |

Fat phase
Fat blend

| | | | | | | | | |
|---|---|---|---|---|---|---|---|---|
| PK4 - INES | 25.000 | 25.000 | 25.000 | 25.000 | 25.000 | 25.000 | 25.000 | 25.000 |
| Rapeseed oil | 75.000 | 75.000 | 75.000 | 75.000 | 75.000 | 75.000 | 75.000 | 75.000 |
| Fat blend total | 100.000 | 100.000 | 100.000 | 100.000 | 100.000 | 100.000 | 100.000 | 100.000 |

Other fat ingredients

| | | | | | | | | |
|---|---|---|---|---|---|---|---|---|
| Moringa, mono- | 0.150 | 0.300 | 0.600 | 1.200 | | | | |
| diglyceride 102 | | | | | | | | |
| Moringa, | | | | | 0.150 | 0.300 | 0.600 | 1.200 |
| monoglyceride 105 | | | | | | | | |
| 2% sol. beta-carotene | 0.020 | 0.020 | 0.020 | 0.020 | 0.020 | 0.020 | 0.020 | 0.020 |
| Butter Flavouring | 0.020 | 0.020 | 0.020 | 0.020 | 0.020 | 0.020 | 0.020 | 0.020 |
| 050001 T04184 | | | | | | | | |
| Other fat | 0.190 | 0.340 | 0.640 | 1.240 | 0.190 | 0.340 | 0.640 | 1.240 |
| ingredients total | | | | | | | | |
| Fat phase total | 39.990 | 39.990 | 39.990 | 39.990 | 39.990 | 39.990 | 39.990 | 39.990 |
| RECIPE total (calc. | 100.000 | 100.000 | 100.000 | 100.000 | 100.000 | 100.000 | 100.000 | 100.000 |
| batchsize) | | | | | | | | |

TABLE 19
Processing conditions for the low fat W/O emulsions with natural based MM samples.
Pilot Plant

| | Processing (3-tube lab perfector): | | | | | | | |
|---|---|---|---|---|---|---|---|---|
| | 41 | 42 | 43 | 44 | 45 | 46 | 47 | 48 |
| Oil phase temperature | 50 | 50 | 50 | 50 | 50 | 50 | 50 | 50 |
| Water phase temperature | 50 | 50 | 50 | 50 | 50 | 50 | 50 | 50 |
| Emulsion temperature | 50 | 50 | 50 | 50 | 50 | 50 | 50 | 50 |
| Centrifugal pump | Auto | Auto | Auto | Auto | Auto | Auto | Auto | Auto |
| Capacity high pressure | 40 | 40 | 40 | 40 | 40 | 40 | 40 | 40 |
| pump | | | | | | | | |
| Cooling (NH3) tube 1: | −10 | −10 | −10 | −10 | −10 | −10 | −10 | −10 |
| Cooling (NH3) tube 2: | −10 | −10 | −10 | −10 | −10 | −10 | −10 | −10 |
| Cooling (NH3) tube 3: | −10 | −10 | −10 | −10 | −10 | −10 | −10 | −10 |
| Rpm tube 1: | 1000 | 1000 | 1000 | 1000 | 1000 | 1000 | 1000 | 1000 |
| Rpm tube 2: | 1000 | 1000 | 1000 | 1000 | 1000 | 1000 | 1000 | 1000 |
| Rpm tube 3: | 1000 | 1000 | 1000 | 1000 | 1000 | 1000 | 1000 | 1000 |

The procedure for water droplet size analysis, confocal laser scanning microscopy, and texture analysis are the same as described in Example 1.

### Results & Discussion

The water droplet size distribution date is given in Table 20 for samples 102 and 105, and Table 21 for sample 191

TABLE 20
Water droplet size distribution data for all samples where
samples 41-44 (concentration 0.15, 0.3, 0.6 and 1.2%
respectively) correspond to MM sample 102 with
monoglyceride content of 53%, and samples 45-48
(concentration 0.15, 0.3, 0.6 and 1.2% respectively)
correspond to MM sample 105 with monoglyceride
content of 83%.

| | Average/ | | | |
|---|---|---|---|---|
| Sample ID | St. Dev | 2_5% < μm | 50% < μm | 97_5% < μm |
| DK 17124-1-41 | Average | 2.12 | 9.17 | 39.71 |
| | St. dev. | 0.03 | 0.20 | 2.08 |
| DK 17124-1-42 | Average | 2.02 | 7.80 | 301.2 |
| | St. dev. | 0.03 | 0.21 | 1.32 |
| DK 17124-1-43 | Average | 1.65 | 6.33 | 24.30 |
| | St. dev. | 0.02 | 0.02 | 0.48 |
| DK 17124-1-44 | Average | 1.29 | 4.84 | 18.20 |
| | St. dev. | 0.07 | 0.08 | 1.54 |
| DK 17124-1-45 | Average | 2.06 | 11.61 | 66.25 |
| | St. dev. | 0.10 | 0.80 | 11.62 |
| DK 17124-1-46 | Average | 1.85 | 8.95 | 43.37 |
| | St. dev. | 0.05 | 0.27 | 3.55 |
| DK 17124-1-47 | Average | 1.45 | 6.51 | 29.32 |
| | St. dev. | 0.01 | 0.21 | 1.92 |
| DK 17124-1-48 | Average | 1.46 | 4.13 | 11.71 |
| | St. dev. | 0.04 | 0.09 | 0.80 |

TABLE 21
Water droplet size distribution for 40% fat spread samples containing
MM from sample 191 with a monoglyceride content of 91%

| Sample | 2_5% < μm | 50% < μm | 97_5% < μm |
|---|---|---|---|
| Moringa, 0.3% | 1.31 | 7.47 | 42.41 |
| St. Dev | 0.04 | 0.19 | 2.87 |
| Moringa, 0.6% | 0.95 | 6.04 | 38.56 |
| St. Dev | 0.06 | 0.32 | 6.86 |

The water droplet size for sample 102 at 0.15, 0.30, 0.60 and 1.2% concentration respectively is 39.71, 30.12, 24.30, and 18.20, which shows a clear trend of reduced water droplet size with increasing concentration. Similarly for sample 105 over the same concentration range the respective water droplet size is 66.25, 43.37, 29.32 and 11.71, showing an increasing trend towards lower water droplet sizes and stability. For comparison Table 21 shows the water droplet sizes for the MMs from sample 191 which were noted as having good stability and mouth feel properties. It is worth noting that the water droplet size for sample 191 (91% monoglyceride content) at 0.3 and 0.6% concentration are closer to those from Table 20 for sample 105 (84% monoglyceride content) than sample 102 (53% monoglyceride content), and that the droplet size for sample 102 which is lowest.

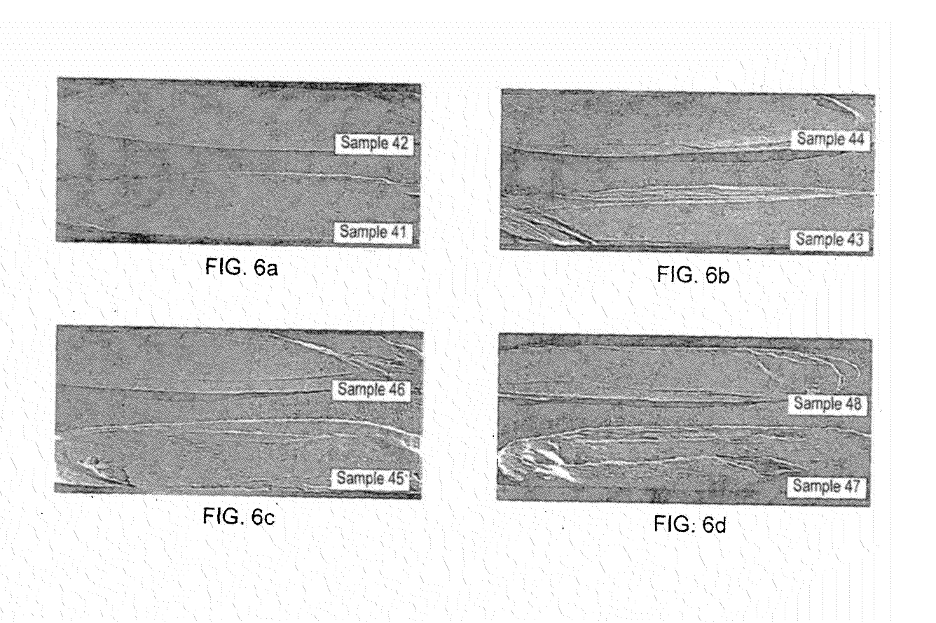

FIG. 6, shows photographic images of the samples after spreading out onto cardboard is presented. As the concentration of the MM increases the samples take on a more solid-like, firmer quality when evaluated by sensory analysis comments made for the samples which stated for sample 102, starting at sample 44 and working to more dilute systems that the emulsion was stable, thick and creamy, and then with subsequent dilutions proceeded to become less thick, and less creamy in mouth feel. The regression in texture continued until the lowest concentration was reached whereby the emulsion was described as uneven. For sample 105, again starting at the highest concentration (sample 48), we regress from a good stable and thick emulsion to one that is showing clear signs of water separation, and not as thick or creamy in terms of mouth feel (sample 45). The other 105 samples are then placed on a sliding scale between these two extremes.

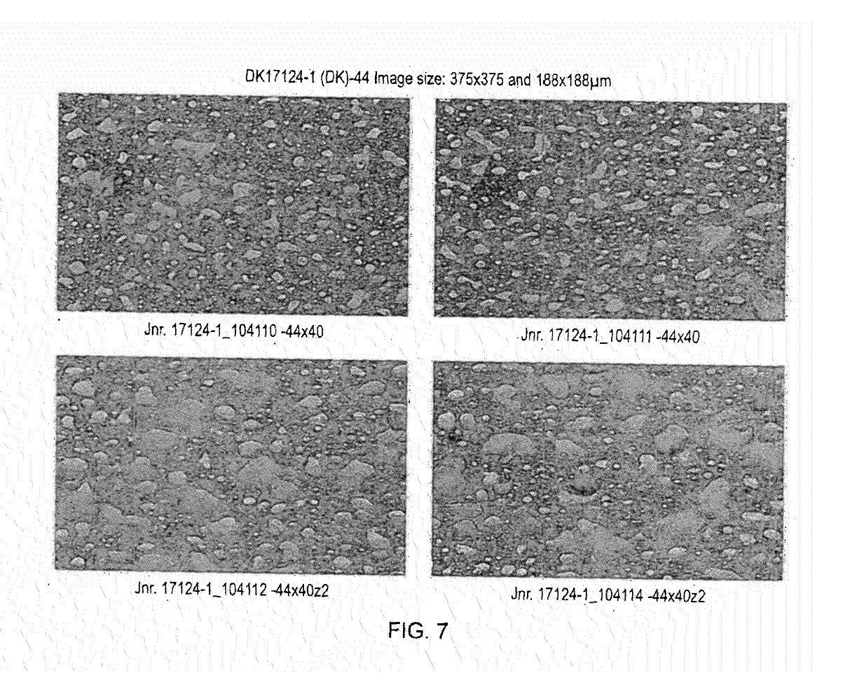

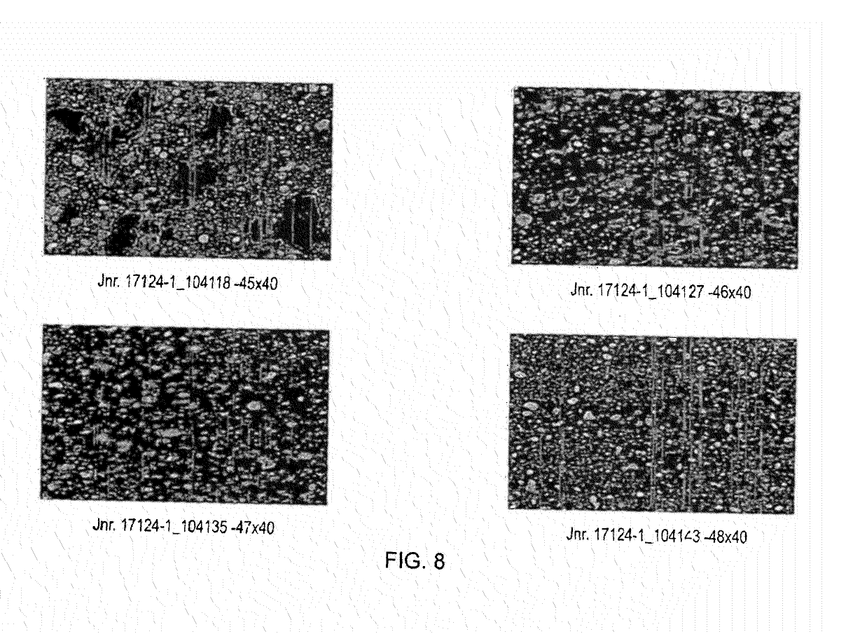

The data presented in FIGS. 7 and 8 show the confocal laser images relating to MM samples 102, and 105 respectively. In both Figures it can be seen that the images corresponding to the lower dosage of the given MM (top left) show a much looser structure compared to the remaining images where concentration increases. This is manifested in the larger droplet sizes apparent. As concentration increases, the droplet size decreases and indicates generally an increase in system stability.

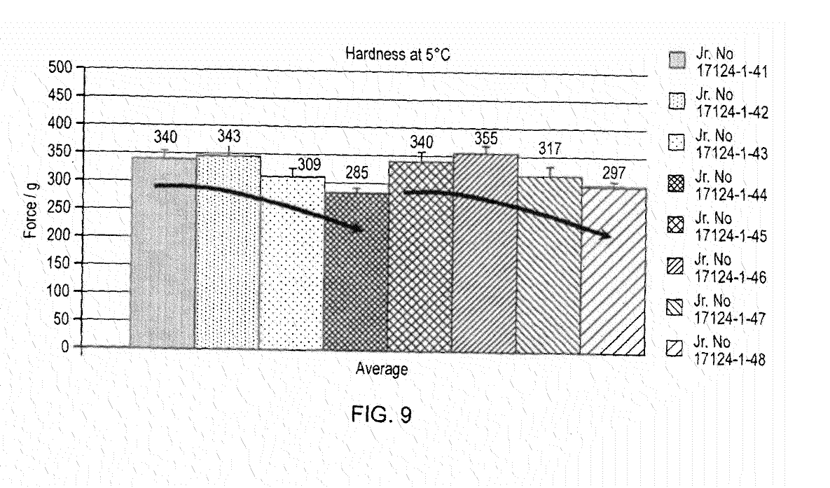

Texture analysis results on hardness are presented in FIG. 9, and show a general reduction in hardness as concentration of MM from either 102 or 105 increases.

It appears that with an increased MM concentration to the highest level of 1.2% (samples 44 and 48) we are seeing a softer kind of structure, which is significantly different from the samples where the concentration is 0.3% (samples 42 and 46). The presence of this softer structure could indicate eutectic type phase behaviour, similar to that seen for PGPR systems.

Thus, this example shows the viability of low fat water in oil emulsion spread systems is good with monoglycerides based on Moringa.

### Conclusion

This example concludes that low fat water in oil emulsion spreads made with Moringa monoglyceride samples 102 and 105 with a monoglyceride content of 53.16 and 82.55% respectively, at given dosages are capable of producing commercially viable products. Indeed 105 (high monoglyceride content), corresponds well to the fully distilled 191.

### Dosage Variation and Reworking

Moringa monoglycerides (MM) are shown above in low fat spreads (LFS) at the 40% fat level. In the following example varying the dosage of MM on the stability of 40% LFS applications were tested as were the ability of the MM to successfully undergo re-work. As discussed herein when using PGPR type emulsifiers, the structure formed can almost be considered as being ‘too good’. This then manifests itself in generally poor re-working ability. The use of MM overcomes this problem.

### Materials & Methods

The recipes for the varying the dosage of the MM in the 40% spreads tested are given in Table 22

TABLE 22
Recipe for the 40% spreads made with varying MM
dosages; sample 31: 0.15% MM; sample 33: 0.07%
MM; 0.07% MM and 0.5% DIMODAN ® UJ.

| Ingredient Name | 31 | 33 | 35 |
|---|---|---|---|
| Water (Tap) | 57.800 | 57.800 | 57.800 |
| Salt (Sodium Chloride) | 0.500 | 0.500 | 0.500 |
| GRINDSTED ® LFS 560 Stabiliser | 1.500 | 1.500 | 1.500 |
| System | | | |
| Skimmed milk powder | 0.100 | 0.100 | 0.100 |
| Potassium Sorbate | 0.100 | 0.100 | 0.100 |
| Water phase total | 60.000 | 60.000 | 60.000 |
| pH | 5.5 | 5.5 | 5.5 |
| PK4-INES | 25.000 | 25.000 | 25.000 |
| COLZAO | 75.000 | 75.000 | 75.000 |
| Fat blend total | 100.000 | 100.000 | 100.000 |
| DIMODAN ® U/J Distilled | | | 0.500 |
| Monoglyceride | | | |
| Distilled Monoglyceride, Moringa | 0.150 | 0.070 | 0.070 |
| Oil (Lot 2461-208) | | | |
| GRINDSTED ® PGPR 90 | 0.100 | 0.100 | 0.100 |
| Polyglycerol Polyricinoleate | | | |
| 2% sol. beta-carotene | 0.020 | 0.020 | 0.020 |
| Butter Flavouring 050001 T03007 | 0.030 | 0.030 | 0.030 |
| Other fat ingredients total | 0.300 | 0.220 | 0.720 |
| Fat phase total | 40.000 | 40.000 | 40.000 |
| RECIPE total (calc. batchsize) | 100.000 | 100.000 | 100.000 |

The procedure for this process is given as follows;

### Water Phase:

1. Heat water to 80° C.
2. Mix dry ingredients
3. Slowly add dry ingredients to the water while stirring intensively. Stir for 4 minutes
4. Cool water phase to 50° C.
5. Re-weigh and add water equivalent to the amount of evaporation
6. Adjust pH with citric acid or NaOH
7. Add flavour just before running the Perfector

### Fat Phase:

1. Weigh out emulsifier, beta carotene (2% solution) and oil/fat in the same container

### 2. Heat to 80° C.

3. Stir the fat phase until mixed well
4. Cool the fat phase to 50° C.
5. Add flavour just before running the Perfector

### Emulsion:

Add the water phase to the fat phase stirring intensively.

The processing conditions on the pilot plant are shown in Table 23

TABLE 23
Plan processing conditions for the recipes given in Table 1.
Pilot Plant

| | Processing (3-tube lab perfector): | | | | | |
|---|---|---|---|---|---|---|
| | 31 | 32 | 33 | 34 | 35 | 36 |
| Oil phase temperature | 50 | 50 | 50 | 50 | 50 | 50 |
| Water phase temperature | 50 | 50 | 50 | 50 | 50 | 50 |
| Emulsion temperature | 50 | 50 | 50 | 50 | 50 | 50 |
| Centrifugal pump | Auto | Auto | Auto | Auto | Auto | Auto |
| Capacity high pressure | 40 | 40 | 40 | 40 | 40 | 40 |
| pump | | | | | | |
| Cooling (NH3) tube 1: | −10 | −10 | −10 | −10 | −10 | −10 |
| Cooling (NH3) tube 2: | −10 | −10 | −10 | −10 | −10 | −10 |
| Cooling (NH3) tube 3: | | | | | | |
| Rpm tube 1: | 1000 | 1000 | 1000 | 1000 | 1000 | 1000 |
| Rpm tube 2: | 1000 | 1000 | 1000 | 1000 | 1000 | 1000 |

The recipes for the samples used to test the re-working ability are given in Table 24. The procedure for producing the recipes in Table 24 is identical to that given above for the recipes outlined in Table 22, and equally the plant processing conditions are likewise identical to those given above in Table 23.

TABLE 24
Recipes of 40% fat spreads used to test re-working ability.
Ingredients in %

| | | |
|---|---|---|
| Ingredient Name | 11 | 15 |

Water phase

| | | |
|---|---|---|
| Water (Tap) | 57.300 | 57.300 |
| Salt (Sodium Chloride) | 1.000 | 1.000 |
| GRINDSTED ® LFS 560 Stabiliser System | 1.500 | 1.500 |
| Skimmed milk powder | 0.100 | 0.100 |
| Potassium Sorbate | 0.100 | 0.100 |
| Water phase total | 60.000 | 60.000 |
| pH | 5.5 | 5.5 |

Fat phase
Fat blend

| | | |
|---|---|---|
| PK4-INES | 25.000 | 25.000 |
| COLZAO | 75.000 | 75.000 |
| Fat blend total | 100.000 | 100.000 |

Other fat ingredients

| | | |
|---|---|---|
| DIMODAN ® U/J Distilled Monoglyceride | 0.500 | |
| Distilled Monoglyceride, Moringa Oil (Lot 2461-208) | | 0.500 |
| 2% sol. beta-carotene | 0.020 | 0.020 |
| Butter Flavouring 050001 T03007 | 0.030 | 0.030 |
| Other fat ingredients total | 0.550 | 0.550 |
| Fat phase total | 40.000 | 40.000 |
| RECIPE total (calc. batchsize) | 100.000 | 100.000 |

The analysis run on the samples was water droplet size distribution, confocal laser scanning microscopy (CLSM), texture analysis and optical photography as described herein.

### Results & Discussion

The water droplet size distribution data for the recipes in Table 22 examining the variation in dosage of MM is given in Table 25.

TABLE 25
Water droplet size distribution data for 40% spreads
with varying MM dosages; sample 31 - 0.15% MM; sample
33 - 0.07% MM; and sample 35 - 0.07% MM + 0.5%
DIMODAN ® UJ.

| | Average/ | 2.5% < | 50% < | 97.5% < |
|---|---|---|---|---|
| Sample ID | St. dev. | μm | μm | μm |
| DK18876-1(DK)-31 | Average | 1.62 | 5.39 | 17.93 |
| | St. dev. | 0.03 | 0.05 | 0.69 |
| DK18876-1(DK)-33 | Average | 1.48 | 6.52 | 29.12 |
| | St. dev. | 0.07 | 0.67 | 7.62 |
| DK18876-1(DK)-35 | Average | 1.74 | 4.42 | 11.24 |
| | St. dev. | 0.10 | 0.08 | 0.64 |

It is clear to see that as the MM dosage reduces the water droplet size increases, and serves to indicate that the LFS sample is becoming less stable. In both cases (samples 31 and 33) the water droplet size is similar to and within the range of the water droplet sizes reported earlier (Wassell, Farmer and Young, 2010). A further reduction in water droplet size is seen for the sample including both MM and DIMODAN® UJ.

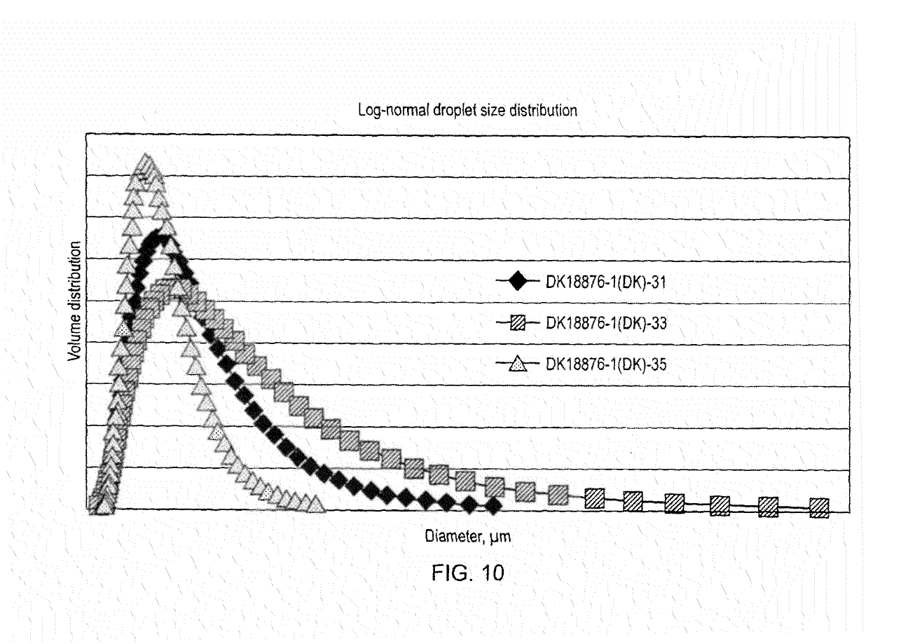

This is graphically represented in FIG. 10.

Re-working of the low fat spreads with MM was achieved by running the finished material immediately through a re-melter fitted to the pilot plant. Here the finished low fat spread was re-melted up to a temperature of 90° C., enough to ensure complete melting of the C22 behenic acid fractions from the MM. This re-melted material was then deposited from the re-melt tanks back into the feed tanks ready to run through the pilot plant again as under normal processing and cooling. No difficulty was experienced during this re-melting process.

The water droplet size distribution for the samples that have undergone re-work are given in Table 26 and show that for the MM containing sample, (no. 15) the water droplet size still indicates that the stability is likely to be high. The water droplet size is low, and well within the recognised stable area, without being so small that the sample may be regarded as overly stable.

TABLE 26
Water droplet size distribution for 40% spreads after
re-working, sample 11 contains 0.5% DIMODAN ®
UJ, and sample 15 0.5% MM.

| | Average/ | 2.5% < | 50% < | 97.5% < |
|---|---|---|---|---|
| Sample ID | St. dev. | μm | μm | μm |
| DK18876-1(DK)-11 | Average | 2.46 | 8.20 | 27.37 |
| | St. dev. | 0.02 | 0.37 | 2.29 |
| DK18876-1(DK)-15 | Average | 2.12 | 5.18 | 12.62 |
| | St. dev. | 0.05 | 0.03 | 0.22 |

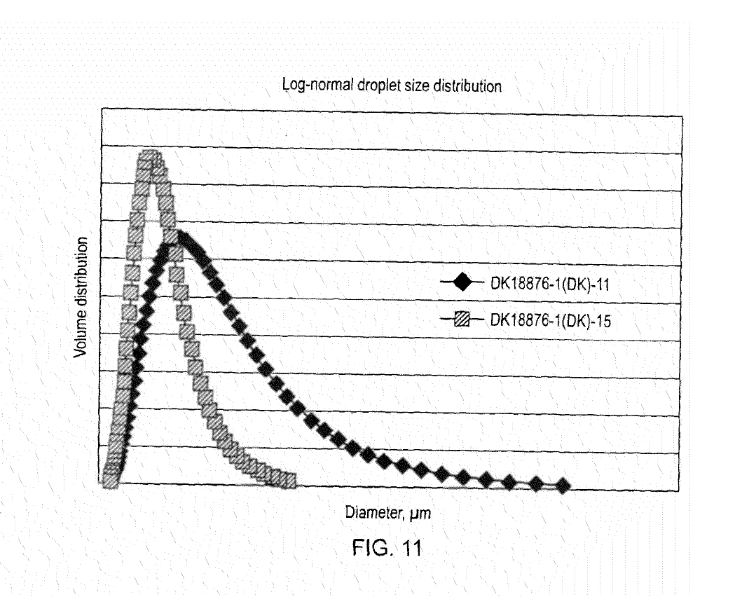

Again graphically, this can be represented in FIG. 11 and shows that the sample with the 0.5% MM has the much narrower water droplet size distribution and therefore points towards a stable system still being attainable after re-work.

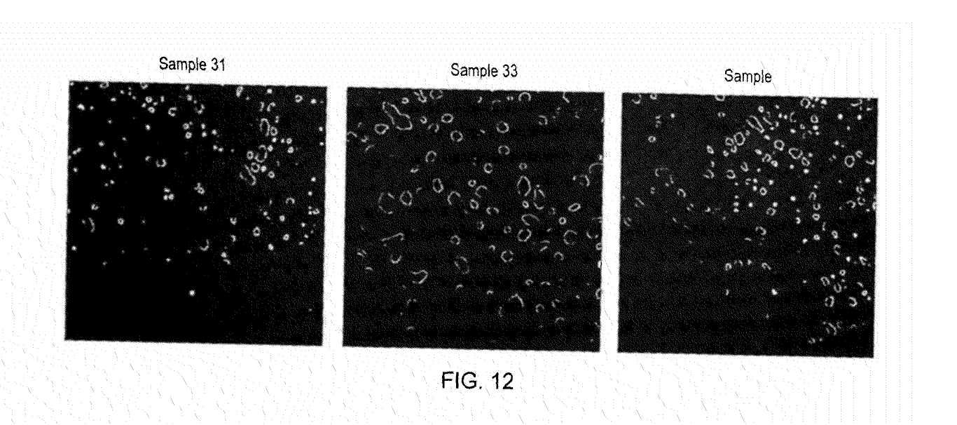

Examining the effect of the water droplet size distribution in terms of the particle size of the actual spreads, one can follow the trend from Table 25 below in FIG. 12. FIG. 12 gives the CLSM images for the 40% spreads at the varying dosages of MM.

Here, one can clearly see an increase in the general size from sample 31 to sample 33, and then the return to a much lower particle size when the combination of DIMODAN® UJ and MM is used in sample 35. It can be concluded that at MM dosages of 0.15 the water droplet size is less than previously found, values of 39.71 microns being reported and therefore the spread here with 0.15% MM falls within the stable range. At 0.07% MM the water droplet size has increased, but is still below the value of 39.71 microns for previously reported 0.15% MM containing samples. The whole system is then strengthened even at the low MM dosage by the presence of the DIMODAN® UJ in sample 35.

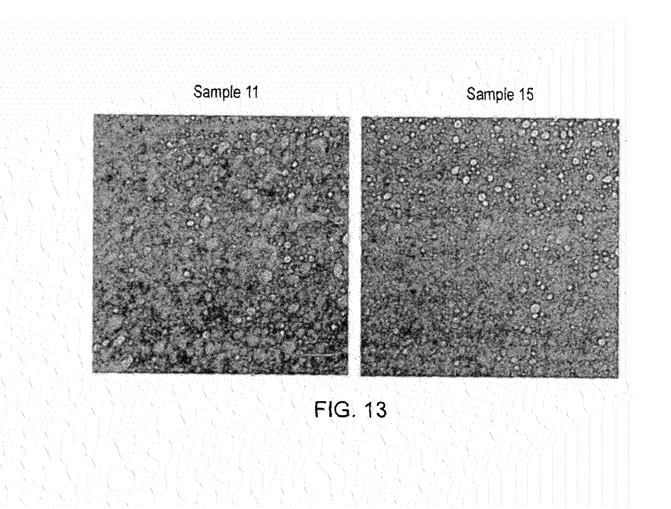

Looking at the CLSM images for the re-working samples of the 40% spreads, data given in FIG. 13 we see a smaller distribution of particles for the sample with 0.5% MM, (sample 15) than for DIMODAN® UJ, (sample 11). This suggests that the sample of 40% fat spreads containing MM may be readily re-worked and will still give a fine stable structure. The water droplet size recorded here is less than corresponding samples reported earlier of 24-29 microns.

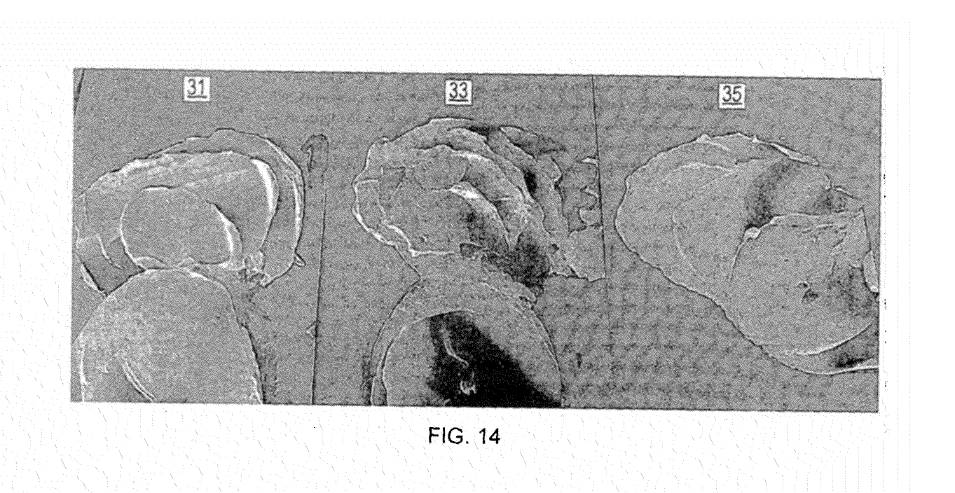

The photographic image of the 40% spreads at varying dosages is given in FIG. 14.

The photographs show that samples 31 and 35 are stable and behaving well to the rigours of the spread test with little sign of breakdown or release of water. However, sample 33 at 0.07% MM is showing a more open structure and obvious signs of breakdown and water release. The structure has become too loose to be viable as an acceptable LFS product.

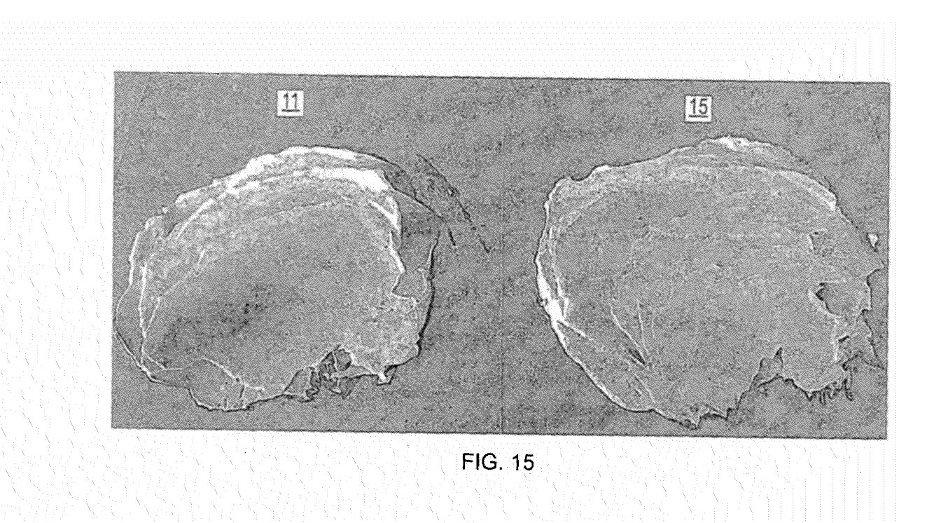

The re-work samples were also photographed, and can be seen in FIG. 15.

Here, the appearance of the samples is very similar. In both cases the sample spreads well on the cardboard and copes well with being spread back and forth. No sign of breakdown is present or release of water. Therefore, at this dosage of 0.5% MM in sample 15, re-working can successfully be performed without adversely affecting the quality of the spread.

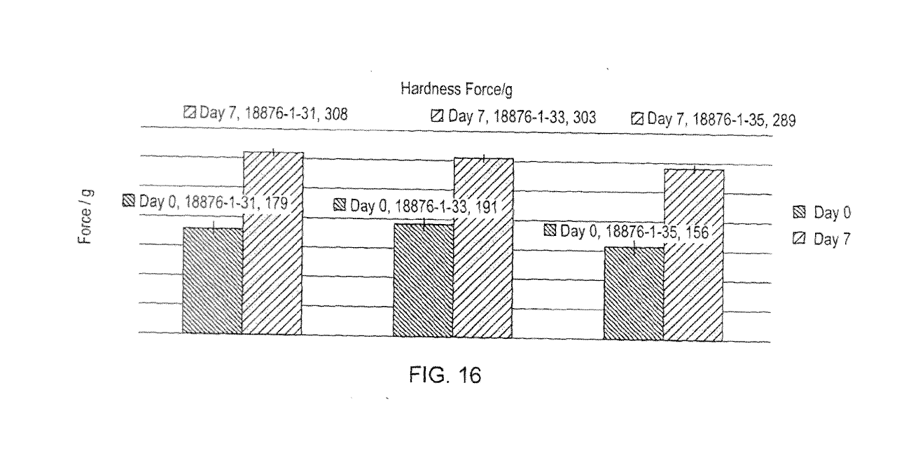

Texture analysis of the 40% spread samples at varying dosage of MM is given in FIG. 16.

After 7 days this result shows that the sample with 0.15% MM gave the firmest result, slightly lower than previously recorded values of 340 g. Interestingly, the sample with 0.07% MM, sample 33, also gave a reasonably high texture hardness. The softest sample was given by sample 35, but this did not reflect badly on its stability.

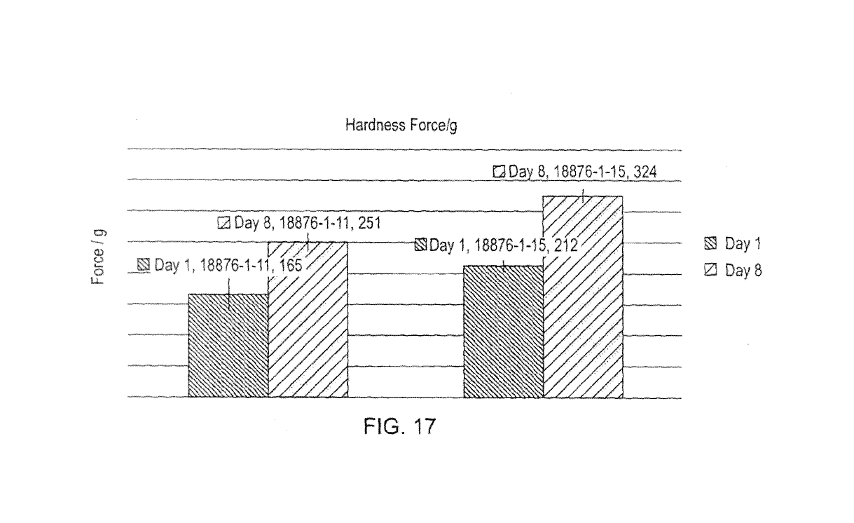

The samples tested for re-working are shown in FIG. 17.

In support of the results of the CLSM images and photographic images together with the visual evaluation the results of FIG. 17 show that the sample containing the MM is firmer than that for DIMODAN® UJ alone. The values are also similar to those for corresponding samples, around 309-317 g, As such, these results indicate that re-working is possible with LFS samples at 40% and at MM dosages of 0.5%,

### Conclusion

40% LFS samples were made with varying MM dosages. It was found that at 0.15% MM the spread was stable and viable, agreeing with previous results. At 0.07% MM the sample became more loose in structure and yet maintained a fairly narrow water droplet size distribution. Under the spreading test the sample released water. This water release was recovered at the same MM dosage of 0.07% by the addition of 0.5% DIMODAN® UJ.

40% LFS samples at 0.5% MM dosage were tested for re-working ability. Here the 0.5% MM sample showed a narrow water droplet size distribution, with small water droplets, leading to a tight emulsion formation. The sample performed well to spreading and showed no sign of breaking or water release. This leads to the conclusion that re-working will not be an issue.

### 28% Fat and 15% Fat Spreads

The above example are based on the incorporation of Moringa Monoglycerides (MM into low fat spreads at 40% fat levels. The present examples incorporates MM at two further fat levels, 28% and 15% fat respectively.

The results described below outline the findings from these trials.

### Materials & Methods

The recipe used for these very low fat spreads (VLFS) at 28 and 15% fat phase respectively is given in table 27, where the samples at each fat level are made with and without mm.

TABLE 27
Recipes used for the VLFS trials at fat content levels of 28 and 15% fat with and without MM.
Ingredients in %

| | | | | | | | | |
|---|---|---|---|---|---|---|---|---|
| Ingredient Name | 21 | 21 | 23 | 23 | 25 | 25 | 27 | 27 |

Water phase

| | | | | | | | | |
|---|---|---|---|---|---|---|---|---|
| Water (Tap) | 69.800 | 69.800 | 69.800 | 69.800 | 81.800 | 81.800 | 81.800 | 81.800 |
| Salt (Sodium | 0.500 | 0.500 | 0.500 | 0.500 | 0.500 | 0.500 | 0.500 | 0.500 |
| Chloride) | | | | | | | | |
| GRINDSTED ® | 1.500 | 1.500 | 1.500 | 1.500 | 2.500 | 2.500 | 2.500 | 2.500 |
| LFS 560 Stabiliser | | | | | | | | |
| System | | | | | | | | |
| Skimmed milk | 0.100 | 0.100 | 0.100 | 0.100 | 0.100 | 0.100 | 0.100 | 0.100 |
| powder | | | | | | | | |
| Potassium Sorbate | 0.100 | 0.100 | 0.100 | 0.100 | 0.100 | 0.100 | 0.100 | 0.100 |
| Water phase total | 72.000 | 72.000 | 72.000 | 72.000 | 85.000 | 85.000 | 85.000 | 85.000 |
| pH | 5.5 | 5.5 | 5.5 | 5.5 | 5.5 | 5.5 | 5.5 | 5.5 |

Fat phase
Fat blend

| | | | | | | | | |
|---|---|---|---|---|---|---|---|---|
| PK4 - INES | 25.000 | 25.000 | 25.000 | 25.000 | 15.000 | 15.000 | 15.000 | 15.000 |
| COLZAO | 75.000 | 75.000 | 75.000 | 75.000 | 85.000 | 85.000 | 85.000 | 85.000 |
| Fat blend total | 100.000 | 100.000 | 100.000 | 100.000 | 100.000 | 100.000 | 100.000 | 100.000 |

Other fat ingredients

| | | | | | | | | |
|---|---|---|---|---|---|---|---|---|
| DIMODAN ® U/J | 0.500 | 0.500 | | | 0.600 | 0.600 | | |
| Distilled | | | | | | | | |
| Monoglyceride | | | | | | | | |
| (KAB) Distilled | | | 0.500 | 0.500 | | | 0.600 | 0.600 |
| Monoglyceride, | | | | | | | | |
| Moringa Oil (Lot | | | | | | | | |
| 2461-208) | | | | | | | | |
| GRINDSTED ® | 0.200 | 0.200 | 0.200 | 0.200 | 0.200 | 0.200 | 0.200 | 0.200 |
| PGPR 90 | | | | | | | | |
| Polyglycerol | | | | | | | | |
| Polyricinoleate | | | | | | | | |
| 2% sol. beta-carotene | 0.020 | 0.020 | 0.020 | 0.020 | 0.020 | 0.020 | 0.020 | 0.020 |
| Butter Flavouring | 0.030 | 0.030 | 0.030 | 0.030 | 0.030 | 0.030 | 0.030 | 0.030 |
| 050001 T03007 | | | | | | | | |
| Other fat | 0.750 | 0.750 | 0.750 | 0.750 | 0.850 | 0.850 | 0.850 | 0.850 |
| ingredients total | | | | | | | | |
| Fat phase total | 28.000 | 28.000 | 28.000 | 28.000 | 15.000 | 15.000 | 15.000 | 15.000 |
| RECIPE total (calc. | 100.000 | 100.000 | 100.000 | 100.000 | 100.000 | 100.000 | 100.000 | 100.000 |
| batchsize) | | | | | | | | |

The procedure for this process is as follows;

### Water Phase:

1. Heat water to 80° C.
2. Mix dry ingredients
3. Slowly add dry ingredients to the water while stirring intensively. Stir for 4 minutes.
4. Cool water phase to 50° C.
5. Re-weigh and add water equivalent to the amount of evaporation
6. Adjust pH with citric acid or NaOH
7. Add flavour just before running the Perfector

### Fat Phase;

1. Weigh out emulsifier, beta carotene (2% solution) and oil/fat in the same container

### 2. Heat to 80° C.

3. Stir the fat phase until mixed well
4. Cool the fat phase to 50° C.
5. Add flavour just before running the Perfector

### Emulsion:

Add the water phase to the fat phase stirring intensively

The process conditions of the pilot plant were as follows;

TABLE 28
Process conditions on Pilot plant for recipes outlined in Table 1.
Pilot Plant

| | Processing (3-tube lab perfector): | | | | | | | |
|---|---|---|---|---|---|---|---|---|
| | 21 | 22 | 23 | 24 | 25 | 26 | 27 | 28 |
| Oil phase temperature | 50 | 50 | 50 | 50 | 50 | 50 | 50 | 50 |
| Water phase temperature | 50 | 50 | 50 | 50 | 50 | 50 | 50 | 50 |
| Emulsion temperature | 50 | 50 | 50 | 50 | 50 | 50 | 50 | 50 |
| Centrifugal pump | Auto | Auto | Auto | Auto | Auto | Auto | Auto | Auto |
| Capacity high pressure | 40 | 40 | 40 | 40 | 40 | 40 | 40 | 40 |
| pump | | | | | | | | |
| Cooling (NH3) tube 1: | −10 | −10 | −10 | −10 | −10 | −10 | −10 | −10 |
| Cooling (NH3) tube 2: | −10 | −10 | −10 | −10 | −10 | −10 | −10 | −10 |
| Rpm tube 1: | 1000 | 1000 | 1000 | 1000 | 1000 | 1000 | 1000 | 1000 |
| Rpm tube 2: | 1000 | 1000 | 1000 | 1000 | 1000 | 1000 | 1000 | 1000 |

The analysis run on the samples was water droplet size distribution, confocal laser scanning microscopy (CLSM), texture analysis and optical photography as described herein.

### Results & Discussion

The results of the water droplet size are given in Table 29.

TABLE 29
water droplet size distribution for VLFS 28% fat spreads
without MM (sample 21), with MM (sample 23), and 15%
fat spreads without MM (sample 25) and with MM
(sample 27).

| | Average/ | 2.5% < | 50% < | 97.5% < |
|---|---|---|---|---|
| Sample ID | St. dev. | μm | μm | μm |
| DK18876-1(DK)-21 | Average | 2.37 | 8.14 | 27.89 |
| | St. dev. | 0.03 | 0.23 | 1.27 |
| DK18876-1(DK)-23 | Average | 2.10 | 5.87 | 16.44 |
| | St. dev. | 0.06 | 0.06 | 0.68 |
| DK18876-1(DK)-25 | Average | 2.75 | 23.07 | 196.00 |
| | St. dev. | 0.19 | 1.72 | 42.50 |
| DK18876-1(DK)-27 | Average | 3.20 | 37.63 | 446.73 |
| | St. dev. | 0.29 | 1.53 | 77.06 |

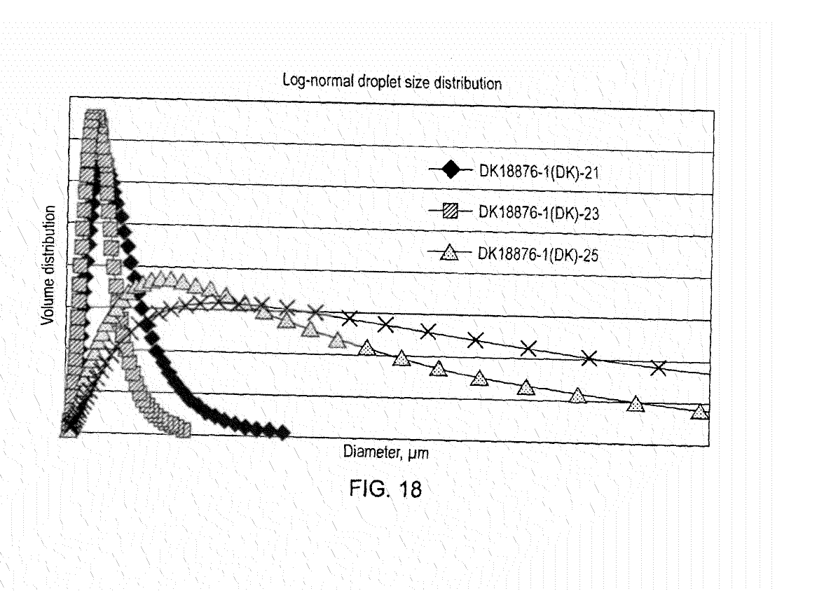

For the 28% fat spreads one can observe that the sample with MM (sample 23) has a smaller water droplet size distribution compared to the sample containing DIMODAN® UJ), thereby indicating from previous experience a tighter, more stable emulsion. The trend of these numbers can be expressed graphically in FIG. 18 which shows the partial extent of the water droplet size distribution for both fat levels of the VLFS samples.

Despite the disparity of the fat levels of the spreads with those reported herein, being 40%, the values of the water droplet size reported here for 28% fat spreads is comparable.

Continued fat reduction down to 15% shows a further increase in the water droplet size such that it loses significance to refer to a droplet

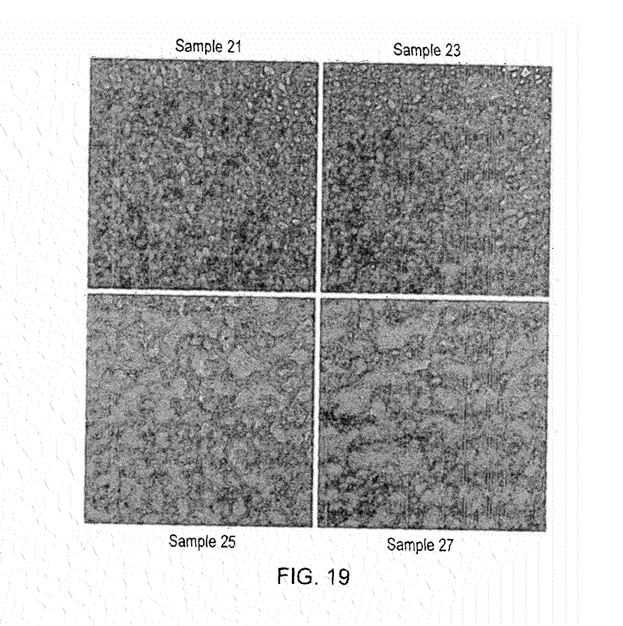

Structurally, these samples described above result in the following CLSM images mirroring the water droplet size distribution data—FIG. 19.

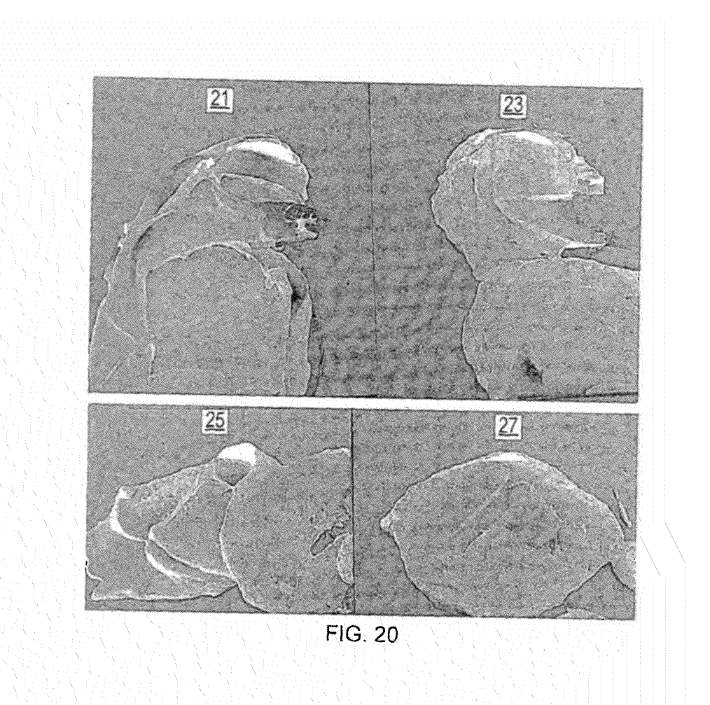

Combining these instrumental based analyses with a visual evaluation and supported by a photograph of the samples spread out on cardboard, one can better see the stability level of each spread. These images are given in FIG. 20.

The images from FIG. 20 corresponding to the 28% fat spreads both show well structured, stable spread bases with little disintegration or loss of water. The emulsion containing MM (sample 23) remained stable despite working with the knife and spreading back and forth. Opening the tub to remove a sample for spreading, the sample showed no signs of oiling out, and in that respect was considered viable.

Reducing the fat level to 15% however, resulted in a less white appearance of the spreads, which were much softer and with a more open structure. Spreading of these samples (samples 25 and 27) showed signs of both breaking down. Water release was apparent in both cases, with samples 25 (with MM) being the better performing.

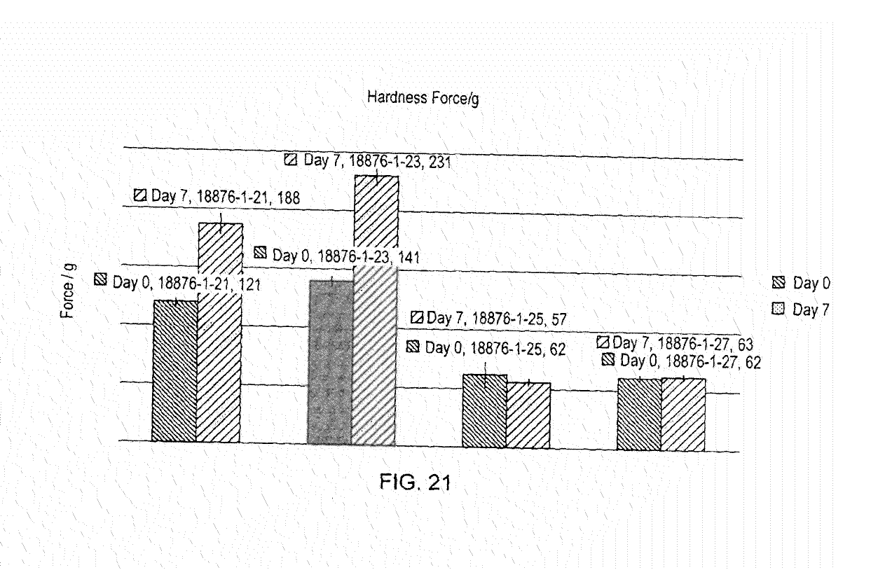

Texture analysis of the samples, focusing on hardness was performed. The samples were measured twice, on day 0 and day 7, and the results are given in FIG. 21

The results support well the spreading test from FIG. 20 together with the visual evaluation; sample 23, with MM at 28% fat level is a more stable, viable spread than sample 21 without MM. The difference in hardness between these two samples is significant enough to be felt during the spreading, but in no way compromised the spreadability of sample 23. Indeed it contributes rather to a spread that feels more stable and more desirable to spread.

The results for sample 25 and 27 are essentially the same and show the each case is soft, and confirms that they both have reduced structure compared to the 28% fat spreads.

### Conclusion

Incorporation of MM into very low fat spreads at 28% fat levels gives a spread which can be deemed similar in performance and nature to those spreads reported previously at 40% fat levels, albeit softer. Water droplet size distribution data and CLSM images were concurrent with previous data. Photographic evidence showed that the sample containing MM looked and behaved similarly to the control and to previously reported samples. The smaller water droplet size could also be seen to result in a harder and therefore more stable spread when viewed in terms of texture analysis.

Reducing the fat level to 15% resulted in less stable spreads having a soft and open structure.

### REFERENCES

Mullin, J. W. (1993) “Crystallisation” 3^{rd} Ed. Butterworth-Heinemann, UK. Pp 292-293.
Sakamoto, M., Maruo, K., Kuiryama, J., Kouno, Ueno, S, and Sato. K. (2003) “Effects of adding polyglycerol behenic acid esters on the crystallisation of palm oil” Journal of Oleo Science, 52, 639-645.
Wassell and Young (2007) “Food applications of trans fatty acid substitutes” International Journal of Food Science and Technology 42, 503-517.
Wassell, P. (2006) “Investigation into the Performance of Emulsified Liquid Shortening Containing Palm-Based Hard Stocks” Palm Oil Developments 45, 1-11.
Wassell, P. Bonwick, G., Smith, C. J., Almiron-Roig, E., and Young, N. W. G. (2010) Towards a Multidisciplinary Approach to Structuring in Reduced Saturated Fat-Based Systems—A Review” International Journal of Food Science and Technology 45 (4), 642-655.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A foodstuff in the form of a spread, wherein the spread is a water in oil emulsion containing
(a) a continuous fat phase; and
(b) a dispersed aqueous phase,
wherein the spread comprises
(i) triglycerides in an amount of less than 41 wt % based on the foodstuff; and
(ii) a mono or di ester of glycerol and Moringa oil.

2. A spread according to claim 1 containing (i) triglycerides in an amount of less than 40 wt % based on the foodstuff.

3. A spread according to claim 1 containing (i) triglycerides in an amount of less than 30 wt % based on the foodstuff.

4. A spread according to claim 1 wherein the spread further comprises polyglycerol polyricinoleic acid.

5. A spread according to claim 2 wherein the spread further comprises polyglycerol polyricinoleic acid.

6. A spread according to claim 3 wherein the spread further comprises polyglycerol polyricinoleic acid.

7. A spread according to claim 1 wherein the mono or di ester of glycerol and Moringa oil is present in the low fat spread in an amount of from about 0.01 to about 10.0% w/w based on the total weight of the low fat spread.

8. A spread according to claim 2 wherein the mono or di ester of glycerol and Moringa oil is present in the low fat spread in an amount of from about 0.01 to about 10.0% w/w based on the total weight of the low fat spread.

9. A spread according to claim 3 wherein the mono or di ester of glycerol and Moringa oil is present in the low fat spread in an amount of from about 0.01 to about 10.0% w/w based on the total weight of the low fat spread.

10. A spread according to claim 4 wherein the mono or di ester of glycerol and Moringa oil is present in the low fat spread in an amount of from about 0.01 to about 10.0% w/w based on the total weight of the low fat spread.

11. A spread according to claim 5 wherein the mono or di ester of glycerol and Moringa oil is present in the low fat spread in an amount of from about 0.01 to about 10.0% w/w based on the total weight of the low fat spread.

12. A spread according to claim 6 wherein the mono or di ester of glycerol and Moringa oil is present in the low fat spread in an amount of from about 0.01 to about 10.0% w/w based on the total weight of the low fat spread.

13. A spread according to claim 7 wherein the mono or di ester of glycerol and Moringa oil is present in the low fat spread in an amount of from about 0.15 to about 1.2% w/w based on the total weight of the low fat spread.

14. A process for preparing a foodstuff in the form of a spread, wherein the spread comprises triglycerides in an amount of less than 41 wt % based on the foodstuff, comprising the steps of
(a) contacting
(i) a fat phase; and
(ii) an aqueous phase;
(b) forming an emulsion wherein the fat phase provides a continuous phase and wherein the aqueous phase provides a dispersed phase; and
(c) contacting the fat phase and the aqueous phase either before step (b) or after step (b) with a mono or di ester of glycerol and Moringa oil.

15. The process according to claim 14 wherein the mono or di ester of glycerol and Moringa oil is present in the fat phase of step (a).

16. A process for preparing or stabilizing a spread using a mono or di ester of glycerol and Moringa oil, wherein the spread is a water in oil emulsion containing
(a) a continuous fat phase; and
(b) a dispersed aqueous phase,
wherein the spread comprises (i) triglycerides in an amount of less than 41 wt % based on the foodstuff.

17. The process of claim 16 comprising the preparation of a spread which is stable in use and which may separated into constituent components.

18. A spread as set forth in Examples 1 and 2.

19. A process for preparing a foodstuff in the form of a spread as set forth in Examples 1 and 2.

20. A process for preparing or stabilizing a spread using a mono or di ester of glycerol and Moringa oil as set forth in Examples 1 and 2.
